(19) United States
(12) Patent Application Publication
(10) Pub. No.: US 2018/0156734 A1
(43) Pub. Date: Jun. 7, 2018

(54) MULTI-TEST ASSAY SYSTEMS AND METHODS OF USING THE SAME

(71) Applicant: BILL & MELINDA GATES FOUNDATION, Seattle, WA (US)

(72) Inventors: Ian Blanch, Seattle, WA (US); William T. Dietze, Seattle, WA (US); Kyle S. Johnston, Sammamish, WA (US); Tim F. Ramsey, Seattle, WA (US); Wallace C. White, Seattle, WA (US)

(21) Appl. No.: 15/370,091

(22) Filed: Dec. 6, 2016

Related U.S. Application Data
(63) Continuation of application No. 15/369,431, filed on Dec. 5, 2016.

(51) Int. Cl. G01N 21/78; G01N 35/00; G01N 21/27

(52) U.S. Cl. CPC G01N 21/78; G01N 2035/00683; G01N 35/00732; G01N 35/00663; G01N 21/272; G01N 2035/00099; G01N 2035/00306; G01N 2035/00326; G01N 2035/00376; G01N 2035/00445; G01N 2035/00524; G01N 2035/00485; G01N 2035/00782; G01N 2035/00752; G01N 35/00029

(57) ABSTRACT

Embodiments disclosed herein are directed to multi-test assay systems for analyzing biological material and methods of using such multi-test assay systems. For example, the multi-test assay system can detect or identify one or more biological markers representative of or corresponding to an illness or disease.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)).

### PRIORITY APPLICATIONS

For purposes of the USPTO extra-statutory requirements, the present application constitutes a continuation of U.S. patent application Ser. No. 15/369,431, entitled MULTI-TEST ASSAY SYSTEMS AND METHODS OF USING THE SAME, naming IAN BLANCH; WILLIAM T. DIETZE; KYLE S. JOHNSTON; TIM F. RAMSEY; AND WALLACE C. WHITE as inventors, filed Dec. 5, 2016, which is currently co-pending or is an application of which a currently co-pending application is entitled to the benefit of the filing date.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### BACKGROUND

Analyzing biological material can help identify and treat various illnesses. For example, body fluids can carry information about one or more diseases or illnesses of an individual. Timely and accurate analysis can help provide an accurate diagnoses and treatment plan, which can improve quality of life and reduce mortality and morbidity of individuals.

Accordingly, users and manufacturers of biological material analyzers continue to seek improvements thereto.

### SUMMARY

Embodiments disclosed herein are directed to multi-test assay systems for analyzing biological material and methods of using such multi-test assay systems. For example, the multi-test assay system can detect or identify one or more biological markers representative of or corresponding to an illness or disease. In an embodiment, the multi-test assay system can accept one or more assay cartridges with one or more corresponding biological materials and can detect light emission from one or more portions of the assay cartridges; the multi-test assay system can analyze the emitted light to determine or identify the one or more biological markers or identifiers of the biological material. It should be appreciated that the biological material can generate light emission via any number of mechanisms, including by reflecting light, emitting light, fluorescing, combinations thereof, etc. The multi-test assay system can correlate results of the analysis of the detected light to one or more diagnoses or conditions corresponding to or associated with one or more diagnoses for one or more individuals (e.g., based on a sample from one individual or from a pool of samples from multiple individuals) who provided the biological material.

In an embodiment, a multi-test assay system is disclosed. The multi-test assay system includes a receptacle sized and configured to secure at a selected position and orientation an assay cartridge of one or more assay cartridges containing biological material. Moreover, the multi-test assay system includes one or more light sources configured to illuminate one or more selected locations relative to the receptacle with one or more excitation lights, an image detector, and a spectrograph. The spectrograph includes an output operably coupled to the image detector. Also, the spectrograph is positioned and configured to channel at least some target light from the one or more selected locations to the image detector. The spectrograph also includes at least one dispersion element configured to disperse the target light, thereby producing dispersed-target-light and directing the dispersed-target-light onto the image detector.

In an embodiment, a multi-test assay system is disclosed. The multi-test assay system includes a plurality of receptacles, each of which is sized and configured to secure at a selected location and orientation an assay cartridge of one or more assay cartridges containing biological material. The multi-test assay system also includes a plurality of light sources configured to illuminate one or more selected locations relative to each of the plurality of receptacles with one or more excitation lights. The multi-test assay system includes one or more light analyzer assemblies. Each of the one or more light analyzer assemblies includes an image detector and a spectrograph configured to channel target light from at least one of the one or more selected locations to the image detector. The spectrograph includes at least one dispersion element configured to disperse the target light, thereby producing a dispersed-target-light and direct the dispersed-target-light onto the image detector.

In an embodiment, a method of analyzing a biological material is disclosed. The method includes exposing a cartridge containing the biological material to one or more light sources outputting light at one or more selected wavelengths. The method also includes guiding target light generated from the exposure to an input of a spectrograph, and dispersing the target light with the spectrograph and outputting dispersed-target-light to an image detector. Moreover, the method includes, at a controller, determining a signal light within the dispersed-target-light by subtracting one or more of the one or more excitation lights or a background light from the dispersed-target-light received at the image detector.

In an embodiment, a multi-test system for assaying a biological sample in an assay cartridge is disclosed. The multi-test system includes one or more cartridge-locator elements sized and configured to position and orient the assay cartridge. The multi-test system also includes one or more actuators positioned and configured to interface with and operate one or more corresponding cartridge controls on the assay cartridge. Moreover, the multi-test system includes one or more light sources configured to illuminate one or more selected locations relative to the one or more cartridge-locator elements, and a light analyzer assembly. The light analyzer assembly includes an image detector, and a spectrograph configured to transform target light received from at least one of the one or more selected locations to dispersed-target-light received at the image detector.

In an embodiment, a multi-test assay system for assaying biological samples in assay cartridges is disclosed. The multi-test assay system includes a base and a plurality of receptacles operably coupled to the base. Each of the plurality of receptacles includes one or more cartridge-locator elements sized and configured to position and orient the assay cartridges. The multi-test assay system further includes one or more actuators positioned and configured to interface with and operate one or more corresponding cartridge controls on the assay cartridge. The multi-test assay system also includes one or more light sources configured to illuminate one or more selected locations relative to each of the plurality of trays, and a plurality of light analyzer assemblies. Each of the plurality of light analyzer assemblies includes an image detector and a spectrograph configured to transform target light from at least one of the one or more selected locations to dispersed-target-light received at the image detector.

In an embodiment, an assay system is disclosed. The assay system includes one or more assay cartridges, each of which includes one or more reservoirs sized and configured to contain one or more biological samples (e.g., specimens received from one or more patients). Each of the one or more assay cartridges includes one or more cartridge controls positioned and configured to manipulate the one or more biological samples contained in the one or more containment features. Moreover, each of the one or more assay cartridges includes one or more locator features. The assay system also includes a receptacle sized and configured to accept each of the one or more assay cartridges. The receptacle includes one or more cartridge-locator elements configured and located to engage corresponding ones of the one or more locator features to position and orient each assay cartridge. The assay system further includes one or more actuators positioned and configured to engage and operate the one or more corresponding cartridge controls, and one or more light sources configured to illuminate one or more selected locations on each assay cartridge positioned in the receptacle, and a light analyzer assembly. The light analyzer assembly includes an image detector and a spectrograph configured to disperse target light from at least one of the one or more selected locations to dispersed-target-light received at the image detector.

Features from any of the disclosed embodiments can be used in combination with one another, without limitation. In addition, other features and advantages of the present disclosure will become apparent to those of ordinary skill in the art through consideration of the following detailed description and the accompanying drawings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1A is an axonometric view of a multi-test assay system, according to an embodiment;

FIG. 1B is an axonometric cutaway view of the multi-test assay system of FIG. 1A;

FIG. 1C is a partial side view of the multi-test assay system of FIG. 1A with an upper portion thereof in a raised position, according to an embodiment;

FIG. 1D is a partial side view of the multi-test assay system of FIG. 1A with the upper portion thereof in a lowered position, according to an embodiment;

FIG. 2 is a partial axonometric cutaway view of a multi-test assay system, showing a tray in an open position, according to an embodiment;

FIG. 3A is a partial view of a multi-test assay system, showing a tray weighing mechanism, with a tray in a first, partially open position, according to an embodiment;

FIG. 3B is a partial side view of a multi-test assay system, showing the tray weighing mechanism, with the tray in a second, closed position, according to an embodiment;

FIG. 4A is a partial side view of a multi-test assay system, showing a tray weighing mechanism, with a tray in a first position, according to an embodiment;

FIG. 4B is a partial side view of a multi-test assay system, showing the tray weighing mechanism, with the tray in a second position, according to an embodiment;

FIG. 5A is a top view of a tray for a multi-test assay system with a first assay cartridge, according to an embodiment;

FIG. 5B is a top view of a tray for a multi-test assay system with a second assay cartridge, according to an embodiment;

FIG. 5C is a top view of a tray for a multi-test assay system with a third assay cartridge, according to an embodiment;

FIG. 6A is an axonometric view of an upper portion of a multi-test assay system, showing a lower side thereof, according to an embodiment;

FIG. 6B is another axonometric view of the upper portion the multi-test assay system of FIG. 6A, showing an upper side thereof, according to an embodiment;

FIG. 7 is a partial axonometric view of a multi-test assay system, showing actuators thereof, according to an embodiment;

FIGS. 8A-8C are partial cross-sectional views of a multi-test assay system, showing an actuator in respective unengaged, partially engaged, and engaged positions, according to an embodiment;

FIGS. 9A and 9B are partial, exposed axonometric views of an upper portion of the multi-test assay system FIG. 1A, showing an actuator in first and second positions, according to an embodiment;

FIG. 10 is a bottom, partial view of an assay cartridge, according to an embodiment;

FIG. 11 is a partial axonometric view of a lower portion of the multi-test assay system FIG. 1A;

FIG. 12 is a top view of the multi-test assay system FIG. 1A;

FIG. 13 is a partial axonometric cutaway view of the multi-test assay system FIG. 1A;

FIG. 14A-14C are schematic diagrams of a spectrograph that can be used with any of the multi-test assay systems disclosed herein;

FIG. 15 is a working example image as detected by an image detector based on dispersed-target-light projected to the image detector by a spectrograph of a multi-test assay system, according to an embodiment;

FIG. 16 is a cross-sectional view of a light guide, according to an embodiment;

FIG. 17 is a cross-sectional view of an illuminator, according to an embodiment; and

FIG. 18 is an axonometric view of a schematic illustration of a multi-test assay system, according to an embodiment.

### DETAILED DESCRIPTION

Embodiments disclosed herein are directed to multi-test assay systems for analyzing biological material and methods of using such multi-test assay systems. For example, the multi-test assay system can detect or identify one or more biological markers representative of or corresponding to an illness or disease in a sample within an assay cartridge. In an embodiment, the multi-test assay system can accept one or more assay cartridges including one or more corresponding biological materials and can generate light emission from one or more portions of an assay cartridge; the multi-test assay system can analyze the emitted light to determine or identify the one or more biological markers or identifiers of the biological material within the assay cartridge. Moreover, the multi-test assay system can correlate results of the analysis of the emitted light to one or more diagnoses or conditions corresponding to or associated with one or more diagnoses for one or more the individuals (e.g., based on a sample from one individual or from a pool of samples from multiple individuals) who provided the biological material. In an embodiment, the multi-test assay system can receive one or more assay cartridges that can contain biological material. Moreover, the assay cartridges can include one or more cartridge controls that can be operated by corresponding actuators of the multi-test assay system. For example, the actuators can operate the cartridge controls in a manner that produces one or more of a suitable modification of the biological material, flow of the biological material, transformation of the biological material (e.g., concentration, capture, purification, extraction, or labeling), luminescence, as well as other optical characteristics (e.g., fluorescence, phosphorescence, absorption, reflection, scattering, etc.) of the biological material. In an embodiment, the actuators can operate the cartridge controls in a manner that produces one or more necessary or suitable reactions (e.g., polymerase chain reaction (PCR); binding of one or more particles, such as nanoparticles or antibodies, to one or more constituents of the biological material; etc.).

The multi-test assay system can include one or more receptacles (e.g., trays) that can receive a corresponding assay cartridge therein. Generally, the multi-test assay system can be configured to perform any number of suitable assays or tests at each of the receptacles thereof. For example, various assay cartridges can be used in the multi-test assay system in a manner that the assay cartridges can be repeatably positioned in and recognized by the multi-test assay system, such that the multi-test assay system can perform suitable operations each assay cartridge, depending on the specific tests or evaluations designated for each specific assay cartridge. Hence, for example, any number of suitable assay cartridges can be placed at the receptacles for any number of suitable tests; the assay cartridges can contain any number of suitable biological materials and can be configured or can include any number of suitable cartridge controls to suitably manipulate the biological material for one or more particular tests or assays that the multi-test assay system can perform on the biological material. In an embodiment, each of the receptacles and different assay cartridges for different tests can be configured such that any of the different assay cartridges can be accepted at any of the receptacles. In an embodiment, each of the receptacles can be configured to accept a plurality of assay cartridges of different types. In an embodiment, each of the receptacles can be configured to accept a plurality of assay cartridges of different sizes. In an embodiment, each of the receptacles can be configured to accept a plurality of assay cartridges of different sizes wherein each assay cartridge includes common positioning of elements or components at predetermined positions on the assay cartridges.

In an embodiment, as described below in more detail, the multi-test assay system can receive various assay cartridges that can have different testing configurations one from another. Moreover, the multi-test assay system can be configured to identify or correlate various assay cartridges with corresponding tests or assays. In an embodiment, the assay cartridges and the multi-test assay system can include one more locator features that can align all of the acceptable assay cartridges with one or more elements or components of the multi-test assay system (e.g., as may be required or suitable for performing the tests associated with or suitable for the selected assay cartridge).

In an embodiment, each of the various assay cartridges can include one or more of the same locator features (e.g., irrespective of the tests designed for the assay cartridge or biological materials contained therein). For example, the assay cartridges can include one or more test identifiers, as described below in more detail, which can be detected or read by the multi-test assay system (e.g., to determine the specific test(s) or operations to perform on the assay cartridge). For example, the multi-test assay system can include multiple actuators positioned in a known arrangement that correspond to one or more cartridge controls at predetermined positions on the assay cartridges. Furthermore, in an embodiment, the multi-test assay system can determine suitability of the assay cartridge for the test(s) or operation(s) that correspond with the identifiers of the assay cartridge (e.g., the multi-test assay system can determine sufficiency of the biological material(s) included in the assay cartridge for the designated or selected test(s) or operation(s)). For example, if the multi-test assay system determines that the assay cartridge is unsuitable for one or more of the designated tests (e.g., due to insufficient biological material supplied with the assay cartridge), the multi-test assay system can terminate further operations of the assay cartridge or can output a warning related to the unsuitability of the assay cartridge.

In an embodiment, the multi-test assay system can include light analyzer assemblies, and each light analyzer assembly can be associated with one or more of the receptacles (e.g., the multi-test assay system can include multiple receptacles and multiple light analyzers). The light analyzer assembly can receive target light, which includes the signal light emitted or reflected from each of the targets including the biological material (e.g., after the biological material is processed to emit light), to determine presence or absence of one or more biological markers or identifiers. Moreover, a controller can be operably coupled to the light analyzer assembly and can correlate the signals received from the light analyzer assembly with one or more results, such as suggested diagnoses for the individual who provided the biological material. The multi-test assay system can include a user interface attached to the controller (e.g., the user interface can be configured to indicate one or more assay results to a user of the system).

In an embodiment, the light analyzer assembly can include a spectrograph and an image detector or sensor operably coupled to the spectrograph. For example, the light analyzer assembly can receive target light from one or more target locations on the assay cartridge. The target light can include signal light from each of the targets (e.g., biological material at each of the target locations on the assay cartridge) on the assay cartridge. The light analyzer assembly can filter, diffract, refract, or otherwise modify or transform the received target light in a manner that at least partially isolates one or more wavelengths of the signal light or the light emitted from or by the biological material at the target locations. In an embodiment, the light analyzer assembly can include a spectrograph that can redirect (e.g., via refraction) or transform the target light by filtering, dispersing (e.g., diffracting, refracting) or splitting up the wavelengths) of the target light in a manner that at least partially isolates the wavelengths of the signal light in reference to the targets.

In an embodiment, as mentioned, the controller can correlate a presence or an absence of one or more biological markers or identifiers with a diagnosis for the individual who supplied the biological material. For example, the controller can correlate the wavelength(s) of the signal light(s) to the presence or absence of the biological markers or identifiers. Additionally or alternatively, the controller can correlate the wavelength(s) of the signal light(s) to one or more diagnoses for the individual who provided the biological material.

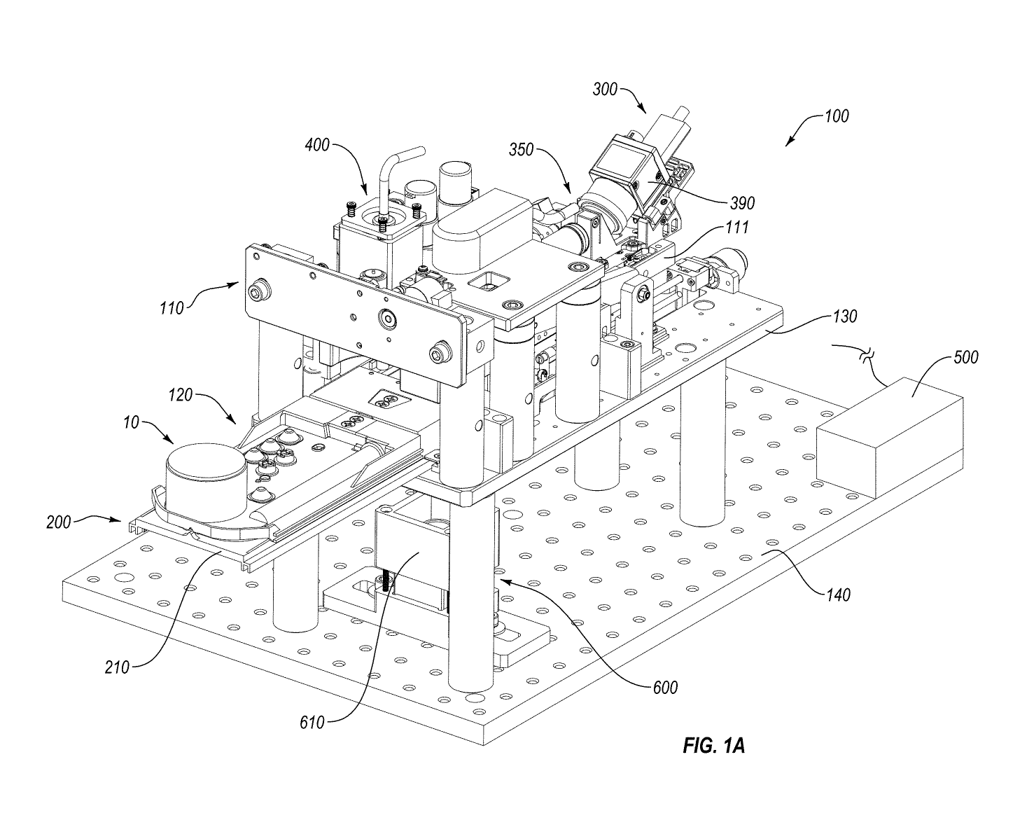

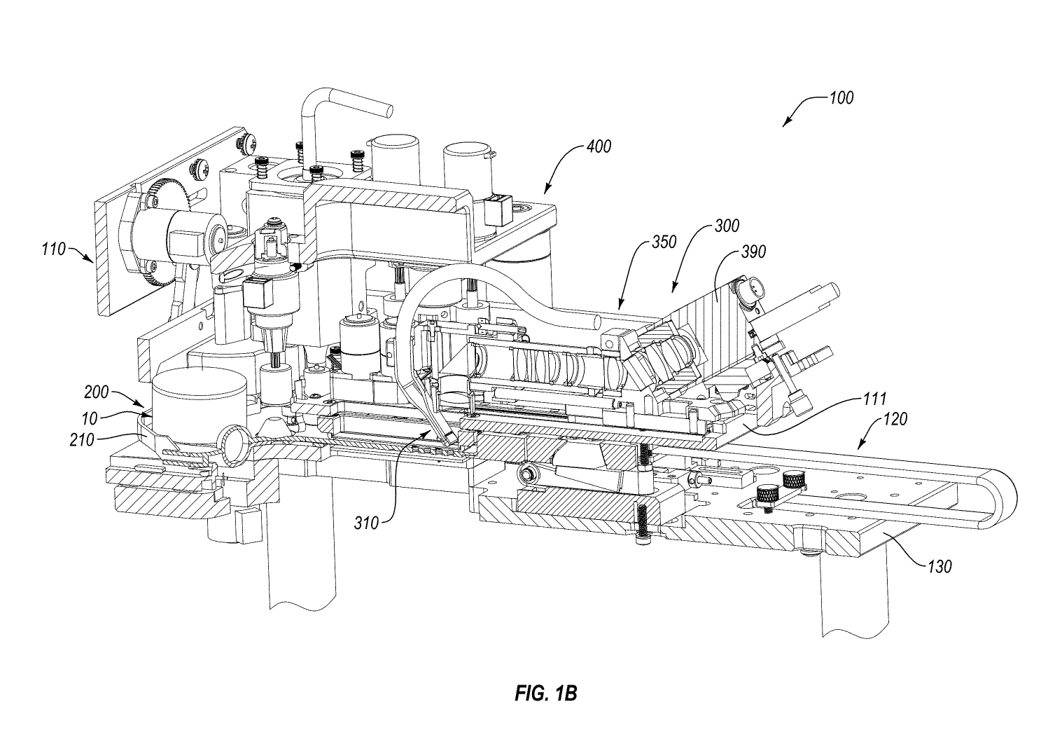

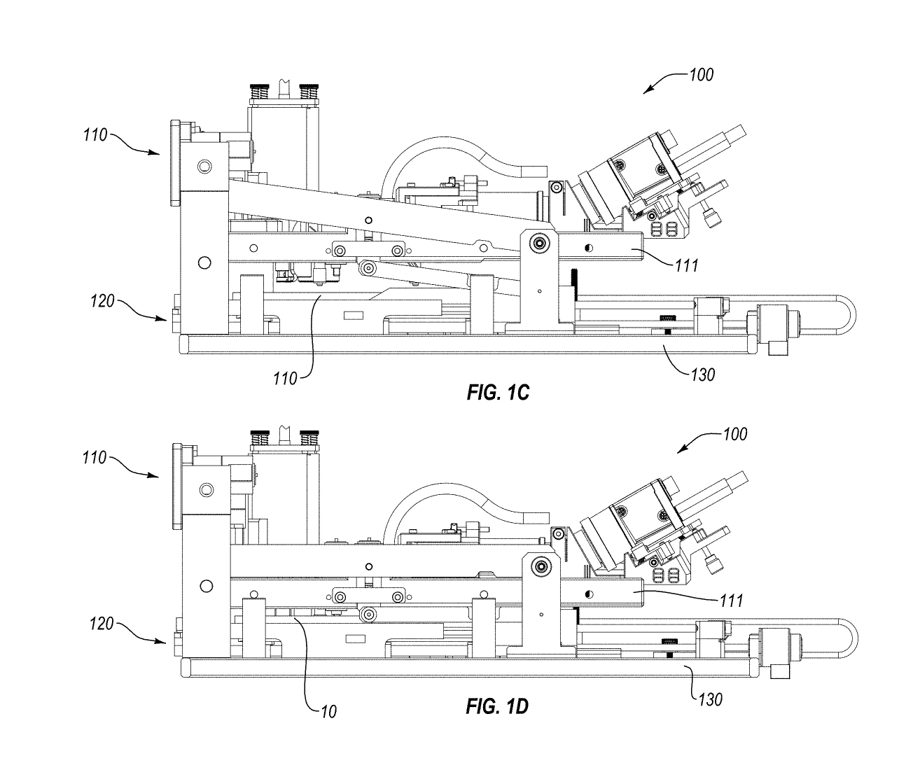

FIGS. 1A-1D illustrate a multi-test assay system 100, according to an embodiment. Specifically, FIG. 1A is an axonometric view of the multi-test assay system 100, and FIG. 1B is an axonometric cutaway view of the multi-test assay system 100. Also, FIG. 1C is a partial side view of the multi-test assay system 100 with an upper portion thereof in a raised position, and FIG. 1D is a partial side view of the multi-test assay system 100 with an upper portion thereof in a lowered position. Moreover, as described above, the multi-test assay system 100 can accept an assay cartridge 10 (FIG. 1A) and can analyze the biological material contained therein to determine or identify one or more biological markers or identifiers in the biological material.

In particular, for example, the multi-test assay system 100 can include a receptacle configured to accept the assay cartridge 10 or another compatible assay cartridge (as described below in more detail). In the illustrated embodiment, the receptacle of the multi-test assay system 100 includes a tray assembly 200 that can accept the assay cartridge 10. More specifically, for example, the tray assembly 200 can include a tray 210 that can be movable between open and closed positions. When the tray 210 is in the open position, the assay cartridge 10 can be positioned on or in the tray 210, as shown in FIG. 1A. In FIG. 1B, the tray is shown in the closed position. When the tray 210 is in the closed position, the assay cartridge 10 can be positioned such that the multi-test assay system 100 can analyze the biological material contained therein.

In an embodiment, the tray assembly 200 can be configured to determine a weight of the assay cartridge 10. For example, as described below in more detail, the tray assembly 200 can include one or more elements or components that can detect the weight of the assay cartridge 10 (e.g., can detect the total weight of the assay cartridge 10 together with the tray 210). Moreover, a controller can receive one or more signals from such elements or components of the tray assembly 200 and can determine the weight of the biological material contained in the assay cartridge 10. For example, the controller can store or receive information corresponding to the weight of an unfilled assay cartridge 10 that does not include the biological material; by subtracting the weight of an empty assay cartridge 10 from the weight of the assay cartridge 10 that includes the biological material, the controller can determine the weight of the biological material contained in the assay cartridge 10. In an embodiment, the controller can determine whether the assay cartridge 10 contains a suitable amount of the biological material for the tests to be performed by the multi-test assay system 100. It should be appreciated that the controller can reset the determined or stored value for the weight after the assay cartridge 10 is removed from the tray assembly 200 or after another assay cartridge is supplied thereto.

In an embodiment, one or more tests that may be performed on the biological material of the assay cartridge 10 may be at least partially based on or dependent upon the amount of the biological material provided with the assay cartridge 10. For example, test procedures or results may be based on values that are proportional or related to the amount of the biological material (e.g. mass or volume of the biological material detected by the multi-test assay system). In an embodiment, the controller can determine one or more values for the test result(s) based at least in part on the weight of the biological material, which can be determined in the manner described herein.

Generally, the multi-test assay system 100 can include an upper portion 110 and a lower portion 120. It should be appreciated, however, that the upper portion 110 and the lower portion 120 are designated for ease of description and elements and components thereof can be associated with any portion of the multi-test assay system 100, as can be suitable for one or more embodiments. In an embodiment, the upper portion 110 or one or more elements or component of the upper portion 110 can be movable relative to the lower portion 120. For example, the upper portion 110 or one or more elements or component of the upper portion 110 can be movable toward and away from the lower portion 120 (e.g., such as to clamp or secure and unclamp the assay cartridge 10 between the upper and lower portions 110, 120).

For example, the lower portion 120 can include a base plate 130 (e.g., one or more elements or components of the lower portion 120 can be mounted on the base plate), and the upper portion 110 can include an upper plate 111 (e.g., one or more elements or components of the upper portion 110 can be mounted on the upper plate 111). As shown in FIG. 1C, when the upper portion 110 is in the raised position, the upper plate 111 (together with elements and components mounted thereon) is spaced farther from the base plate 130 (together with elements and components mounted thereon) of the lower portion 120, than when the upper portion 110 is in the lowered position, shown in FIG. 1D. In an embodiment, the upper portion 110 can move between the lowered and raised positions, as described below in more detail. For example, the assay cartridge 10 can be clamped by and between the upper and lower portions 110, 120, when the upper portion 110 is in the lowered position.

In additional or alternative embodiments, the upper portion 110 and lower portion 120 can be stationary relative to each other. Moreover, in an embodiment, the upper portion 110 or lower portion 120 can include one or more elements or components that can move relative to the upper portion 110 and to lower portion 120. In any event, as described herein, the assay cartridge 10 can be suitably secured in the multi-test assay system 100, such as to facilitate operating one or more cartridge controls of the assay cartridge 10 or performing one or more analyses of the biological material contained in the assay cartridge 10.

Referring back to FIGS. 1A and 1B, the multi-test assay system 100 can include a light analyzer assembly 300 that can receive target light emitted from or by the biological material in the assay cartridge 10 (e.g., responsive to one or more reactions of the biological material or exposure thereof to one or more excitation lights) and can detect the wavelength of the target lights or intensity thereof at one or more selected locations on the assay cartridge. In the illustrated embodiment, the light analyzer assembly 300 can selectively split wavelengths of the target light in the manner that facilitates identification thereof. Additionally or alternatively, in other embodiments, the light analyzer assembly can be configured to filter out one or more wavelengths of light from the target light (e.g., such that a single wavelength, which corresponds to a diagnosis or an identification of a presence or absence of certain biological markers in the biological sample of the assay cartridge, passes through multiple filters for identification). For example, the light analyzer assembly 300 can include one or more light sources (e.g., one or more pump light assemblies 310) that can be configured to illuminate one or more selected locations on the assay cartridge 10 (e.g., thereby exposing the biological material contained in the assay cartridge 10 material to one or more wavelengths or bands of pump light). In some embodiments, the pump light assembly is affixed to a guide that is operable or movable along two or more directions relative to the receptacle, such as relative to the tray assembly (e.g., along two directions orthogonally oriented relative to each other, such as along X-axis and Y-axis of a Cartesian coordinate system).

The light emitted by or from the biological material in the assay cartridge 10 can enter a spectrograph 350. In an embodiment, along with the light from the assay cartridge 10 (e.g., target light comprising signal light from corresponding targets), surrounding light, pump light, etc., can enter the spectrograph 350. In other words, under one or more operating conditions, the total target light that enters the spectrograph 350 can include the signal light for each of the targets and noise light that can obfuscate or interfere with the signal light. Moreover, exposing the biologic materials to the pump lights of different wavelength can result in signal light emissions of different wavelengths from the biological material (e.g., from different portions or samples of the biological material).

In an embodiment, the spectrograph 350 can channel the total target light from the one or more locations on the assay cartridge 10 to an image detector 390. The spectrograph 350 can separate the signal lights, and the noise light can be removed or reduced to determine the wavelength of the signal light corresponding to each of the targets. Moreover, the spectrograph 350 can project or guide the signal light to the image detector 390. Additionally or alternatively, the spectrograph 350 can split or disperse the signal light into multiple light strips of different wavelength (e.g., generally rectangular-shaped sections or portions), such that each strip corresponds to a target on the assay cartridge 10 (e.g., such that the image detector 390 can detect the different wavelengths present in the signal light and locations thereof that can correspond to a location on the assay cartridge 10).

Furthermore, in an embodiment, the light analyzer assembly 300 or one or more portions thereof can move relative to the assay cartridge 10 and relative to the biological material therein. The light analyzer assembly 300 can move to two or more selected locations relative to the assay cartridge 10 to sample or receive target light from biological material (e.g., from processed biological material). In an embodiment, the light analyzer assembly 300 can move among sixteen selected locations to sample or receive the target light. It should be appreciated, however, that the number of selected locations for placing or moving the light analyzer assembly 300 can vary from one embodiment to the next and can depend on one or more test-specific conditions (e.g., the amount of biological material provided, the specific test(s) performed, etc.). Moreover, adjacent ones of the selected locations may have any suitable spacing or distance therebetween, which can vary from one embodiment to another.

In an embodiment, the pump light assembly 310 can illuminate or irradiate the processed biological material at two or more locations on the assay cartridge 10, and the total target light generated from such illumination of the biological material can enter the spectrograph 350 that can manipulate the total target light to isolate signal light therefrom. In some embodiments, the light analyzer assembly is movable along two directions relative to the receptacle, such as relative to the tray assembly (e.g., along two directions orthogonally oriented relative to each other, such as along X-axis and Y-axis of a Cartesian coordinate system). In some embodiments, one or more portions of the light analyzer assembly is movable in both X and Y directions relative to the receptacle, such as relative to the tray assembly.

In an embodiment, the multi-test assay system 100 can include an actuator assembly 400. For example, the actuator assembly 400 can include one or more actuators that can be positioned and configured to interface with and operate one or more corresponding cartridge controls on the assay cartridge 10. For example, the multi-test assay system 100 can operate the cartridge controls of the assay cartridge 10 to produce a suitable flow of the biological material in the assay cartridge 10, for one or more of the following operations: mixing one or more reagents with one or more portions of the biological material, heating or cooling one or more portion of the biological material, sonicating or vibrating one or more portions of the biological material, mixing or breaking up the biological material, filtering biological material, metering biological material or reagents, rehydrating dried or lyophilized reagents, etc. In an embodiment, the biological material in the assay cartridge 10 can be manipulated by the cartridge control in cooperation with the actuators of the actuator assembly 400 to prepare or process one or more portions of the biological material.

For example, processed biological material can luminesce and can produce light of one or more wavelengths at one or more locations on the assay cartridge 10 (e.g., when illuminated by the pump light assembly 310). In an embodiment, the light from the processed biological material can be produced responsive to exposure of the processed biological material to one or more pump lights, which can evoke or produce luminescence or change one or more optical characteristics (e.g., emitted or reflected light wavelengths) of the processed biological at corresponding one or more wavelengths. The light from processed biological material can comprise or can be included in the target light received by the spectrograph 350.

In an embodiment, the multi-test assay system 100 can include at least one controller, such as controller 500, that can be operably coupled to one or more of the tray assembly 200, light analyzer assembly 300, or actuator assembly 400. For example, the controller 500 can operate or direct operation of one or more actuators of the actuator assembly 400 to produce one or more required or suitable reactions in biological material of the assay cartridge 10. In an embodiment, the controller 500 can receive one or more identifiers for the assay cartridge 10, such that the controller 500 can control or direct operations of the actuators of the actuator assembly 400 based on such identifier(s). For example, the assay cartridge 10 can include a barcode, RFID chip, etc., that can include an identifier (e.g., an identification number), and the controller 500 can correlate the identifier of the assay cartridge 10 to one or more tests or operations to be performed thereon (e.g., based on one or more tests for the biological material on the assay cartridge 10). In some embodiments, a controller can operate or direct that one or more operations should not be performed, for example, because an assay cartridge does not include a section corresponding to a particular actuator or system location. In an embodiment, the multi-test assay system is configured to be used with a plurality of assay cartridge types with consistently positioned features on the assay cartridges; it is not necessary, however, that all compatible assay cartridges include all possible features or controls.

Moreover, the controller 500 can receive data or signals from the light analyzer assembly 300, and can determine or identify signal light from corresponding targets of the assay cartridge 10 based at least in part on the signals received from the light analyzer assembly. For example, the controller 500 can be operably coupled to the image detector 390 and can receive signals therefrom, which can correspond to the wavelengths of the signal light for each of the targets. Moreover, the signals received by the controller 500 from the light analyzer assembly 300 can include location information that can identify the location for one, some, or each of the wavelengths of the signal light relative to the assay cartridge 10 (e.g., target locations or location of one or more portions of the biological material or processed biological material). It should be appreciated that the assay cartridge 10 can include one target or multiple targets, such as one or more locations on the assay cartridge 10 where the biological material is suitable for exposure to pump light to produce suitable signal light that can indicate presence or absence of biological markers or identifiers.

In an embodiment, the controller 500 can correlate the signal light or signals received from the image detector 390, which correspond to the signal light received from the biological material or processed biological material, to one or more diagnoses. For example, as noted above, the controller 500 can receive one or more identifiers of the assay cartridge 10. Hence, the controller 500 can correlate the one or more tests performed on the biological material of the assay cartridge 10 and the one or more signal lights (or signals received from the image detector 390, which correspond to the one or more signal lights) to one or more diagnoses for the individual who provided the biological material. In some embodiments, a controller can correlate a signal light or signals received from the image detector to the position of the biological material (e.g., a fluid sample) within the assay cartridge and to the corresponding function(s) of the assay cartridge or operations to be performed thereon. For example, if the controller detects that fluid is not present in a section of the assay cartridge at a particular stage or operation(s) or elapsed time after the start of the assay, the controller can correlate that detection with an error in the assay cartridge or a failure in testing.

In an embodiment, the multi-test assay system 100 can include a quality control or test monitoring system 600. For example, the test monitoring system 600 can include a video camera 610 with a field-of-view suitable for capturing target light from one or more portions of the biological material on the assay cartridge 10. In an embodiment, the assay cartridge 10 can include one or more channels, and the multi-test assay system 100 can manipulate the flow of the biological material through the channels, for example via an actuator. The video camera 610 of the test monitoring system 600 can capture the flow of the biological material in the channels of the assay cartridge 10 (e.g., to assure that the biological material or reactants flow to all suitable or designated points or nodes on the assay cartridge 10 for accurate testing of the biological material). The video camera 610 can be operably coupled to the controller 500. As described below in more detail, based on one or more signals or inputs received from the video camera 610, the controller 500 can determine whether the biological material in the assay cartridge 10 is processed in accordance with one or more protocols. For example, the controller 500 can terminate the test or output an error if one or more test protocols have not been completed (e.g., due to a failure in the flow or other processing of biological material in the assay cartridge 10).

Generally, the packaging (e.g., configuration) or relative positions or locations of the various elements and components of the multi-test assay system 100 can vary from one embodiment to the next. In the illustrated embodiment, the tray assembly 200 is mounted to the base plate 130. Moreover, the light analyzer assembly 300 can be mounted to the base plate 130 in a manner that one or more portions of the light analyzer assembly 300 can move relative to the assay cartridge 10 that can be secured in or to the tray 210 of the tray assembly 200 (e.g., the spectrograph 350 can move to multiple selected locations relative to the tray 210 or assay cartridge 10). Furthermore, the actuator assembly 400 can be mounted to the base plate 130. For example, one or more portions of the actuator assembly 400 can move relative to the tray 210 and assay cartridge 10 (e.g., one or more portions of the actuator assembly 400 can move toward and away from the assay cartridge 10).

As described above, the multi-test assay system 100 can include the test monitoring system 600. For example, the tray assembly 200 and the assay cartridge 10 can be positioned above the test monitoring system 600, such that the field-of-view of the video camera 610 captures suitable portions of the assay cartridge 10. In the illustrated embodiment, the base plate 130 together with the tray assembly 200, light analyzer assembly 300, actuator assembly 400, or combinations thereof can be can be positioned above a support plate and can be supported thereby, such as by one or more support posts. For example, the test monitoring system 600 can be positioned on or near the support plate 140, and the tray assembly 200 can be positioned above the support plate 140.

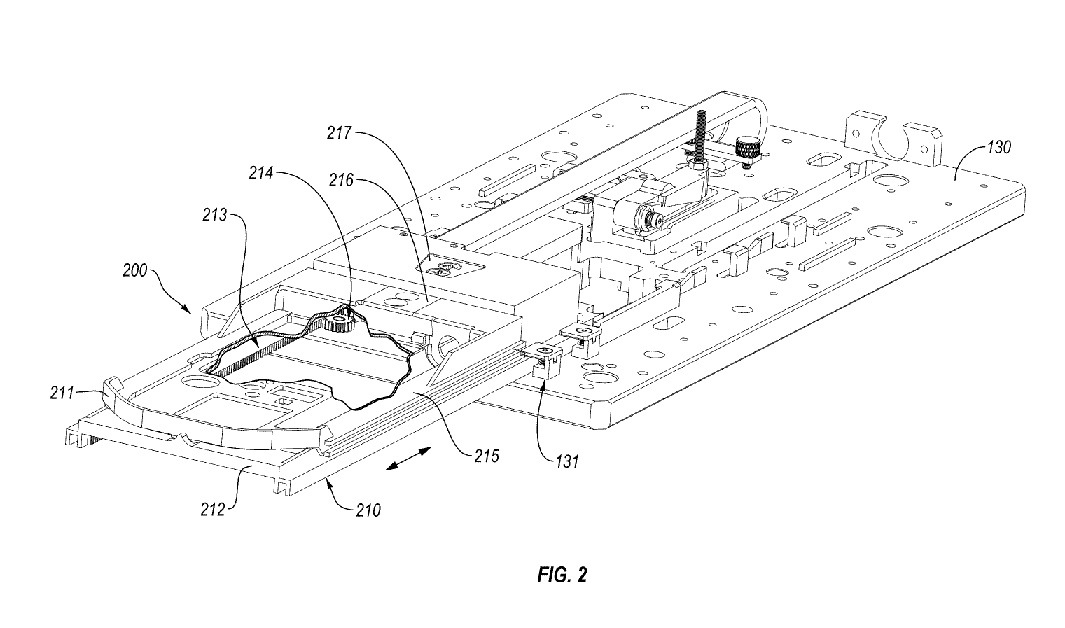

As described above, the tray 210 of the tray assembly 200 can move between open and closed positions. FIG. 2 is partial axonometric cutaway view of the tray assembly 200 mounted to the base plate 130 showing the tray 210 in the open position, according to an embodiment. The tray 210 of the tray assembly 200 can move along a linear path, as indicated with the arrows in FIG. 2. In particular, for example, the tray 210 can move from the open position, where an assay cartridge can be loaded onto the tray 210, to a closed position, where the assay cartridge 10 can be engaged by one or more actuators and can be examined by the light analyzer assembly.

The open-close mechanism of the tray assembly 200, which can open and close the tray 210, can vary from one embodiment to the next. In the illustrated embodiment, the tray assembly 200 can include a rack and pinion arrangement. For example, rotation of the pinion or gear can engage a rack and can move the tray 210 between open and closed positioned. In an embodiment, the controller can operate or direct operation of a motor that can rotate the pinion. Hence, for example, the controller can operate or direct operation of opening and closing of the tray 210 (e.g., responsive to an input received from a user).

In an embodiment, one or more portions of the tray 210 can be sized and configured to position or orient the assay cartridge 10 thereon. For example, the tray 210 can include salver 211 that can be mounted to or integrated with a base 212 of the tray 210. The salver 211 can be permanently secured or can be interchangeable. In any event, in an embodiment, the salver 211 can include one or more cartridge-locator elements that can be sized and configured to position and orient the assay cartridge 10 thereon. Hence, for example, when the tray 210 moves to the closed position, the actuators, light analyzer assembly, monitoring system, or combinations thereof can be aligned or can interface with corresponding portions of the assay cartridge (e.g., the actuators can be aligned to interface with and operate corresponding cartridge controls on the assay cartridge, as described below in more detail).

Generally, the tray 210 can be slidably mounted to the base plate 130 by any number of suitable mechanisms and configurations. For example, as shown in FIG. 2, gibs 131 can define or form one or more channels between an upper surface of the base plate 130 and a surface of the gibs 131. In an embodiment, one or more portions of the tray 210 can be sized and configured to be slidably positioned in the channel formed by the gibs 131 and base plate 130. Moreover, in an embodiment, the channel can be substantially linear, such that the tray 210 can move or slide along a substantially linear path between open and closed configurations, as described herein.

Generally, the tray 210 can be operated or moved between open and closed configurations with any number of suitable mechanisms that can vary from one embodiment to the next. In the illustrated embodiment, the tray 210 includes a rack 213 that can engage pinion 214, such that rotation of the pinion can advance the tray 210 between open and closed positions. For example, a motor 215 can rotate the pinion 214 and move the tray 210 between open and closed positions. In an embodiment, the motor 215 can be operably coupled to the base plate 130 and the pinion 214 can be operably coupled to the motor 215. In any event, for example, responsive to one or more signals received from a controller (e.g., the controller 500), the tray 210 can be moved between open and closed positions (e.g., the motor 215 can receive one or more signals from the controller and can rotate clockwise or counterclockwise responsive thereto, thereby moving the tray 210 toward open or closed position).

As described below in more detail, the multi-test assay system can determine sufficiency of specimen in the assay cartridge before performing one or more tests thereon. For example, a controller of the multi-test assay system can be configured to abort one or more tests or generate a warning when the assay cartridge contains insufficient amount of specimen(s). In an embodiment, the multi-test assay system can weigh the assay cartridge together with the specimen. For example, the controller can receive or store information related to the weight of the assay cartridge without biological material, minimum required amount of biological material, or combinations thereof. Additionally or alternatively, the controller can receive or store information related to the position or locations of the biological material(s) in the assay cartridge. For example, the controller can receive or store information related to the location of a sample within the assay cartridge, minimum required amount of biological material, or combinations thereof. In an embodiment, the controller can determine sufficiency of the biological material (e.g., by subtracting the weight of the empty assay cartridge from the determined total weight of the assay cartridge that includes the specimen to determine whether the assay cartridge contains the minimum required amount of specimen).

In an embodiment, the tray 210 can include a load cell that can be loaded at least with the weight of assay cartridge (e.g., with an empty assay cartridge for determining the weight of the empty assay cartridge or with the assay cartridge that includes biological material). For example, the salver 211, which can be included in the tray 210, can include a load cell 216. In an embodiment, the load cell 216 can be positioned near a distal end of the salver 211 (e.g., near the end closest to the base plate 130, when the tray 210 is in the open position). In the illustrated embodiment, a load block 217 can secure the load cell 216 to the salver 211. Additionally or alternatively, the load cell 216 can be connected to or integrated with any suitable portion or element of the salver 211 or with the another portion or element of the multi-test assay system (e.g., the load cell 216 can be operably coupled to the base plate 130).

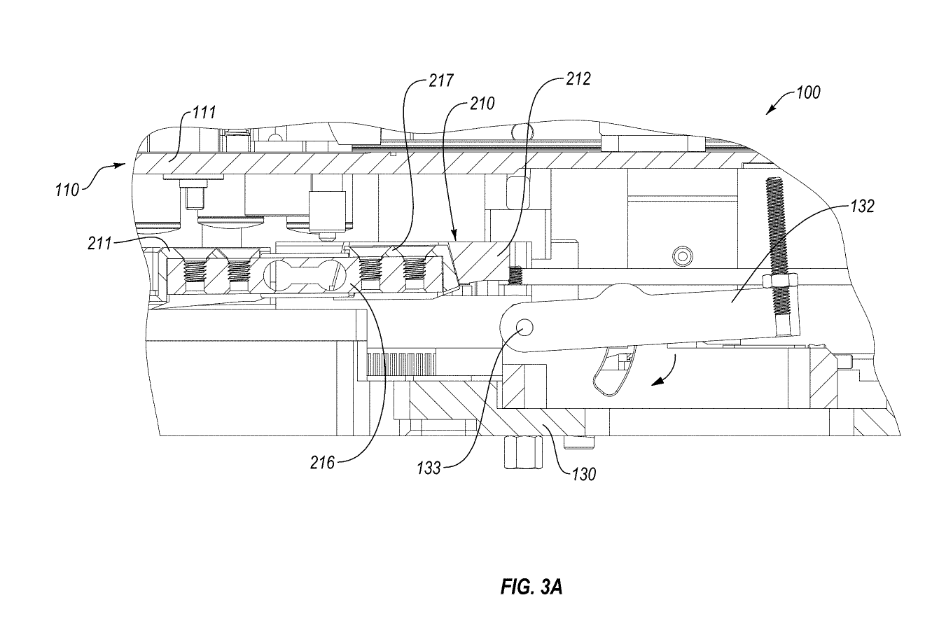

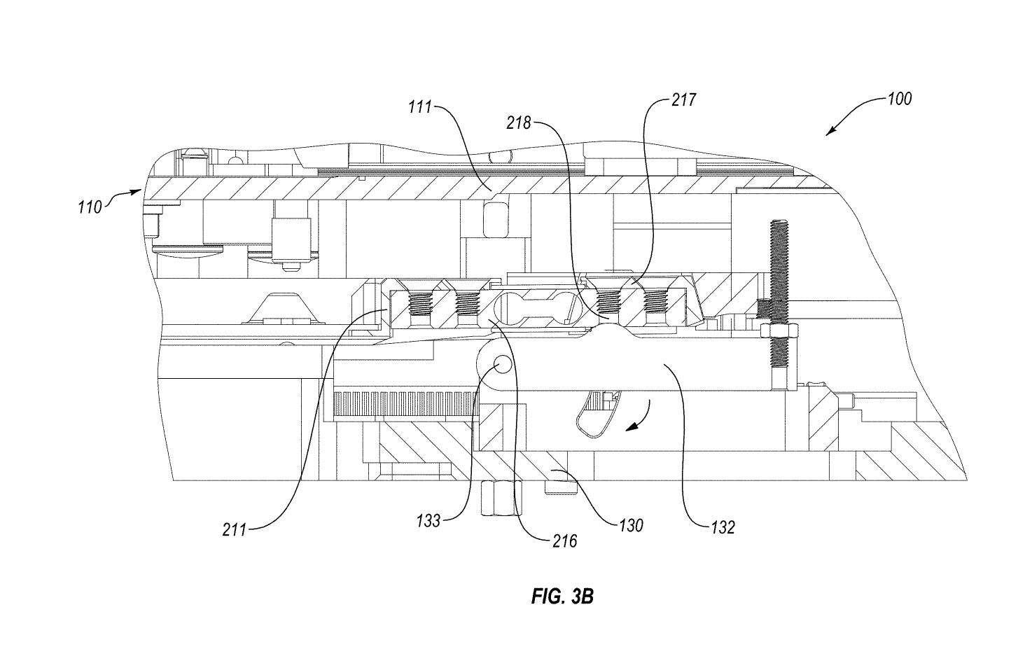

In an embodiment, as shown in FIGS. 3A and 3B, the multi-test assay system 100 can include a spring-loaded lever 132 that can at least partially suspend or cantilever the tray 210 in a manner that loads load cell 216 of the salver 211. For example, the salver 211 can be suspended between a first support location 218 and a second support location located at a selected or predetermined distance from the first support location 218. In an embodiment, suspending the salver 211 between the first support location 218 and another support location can exert a force onto the load cell 216 that can be correlated to the weight of the salver 211 and the assay cartridge contained thereon.

For example, the controller 500 (FIG. 1A) can receive signals from the load cell 216 that can be correlated to the weight of the salver 211 and the assay cartridge 10. The controller 500 can include a database, a table, etc., to store and access data related to the weight of the salver 211 without the assay cartridge, weight of the assay cartridge without the biological material, etc. The database, table, etc. can be updated via a barcode on the cartridge, data included with a shipment of assay cartridge(s), the Internet, etc. In an embodiment, the controller 500 can determine the weight of the assay cartridge 10 by subtracting the weight of the salver 211 from the total determined weight of the salver 211 and the assay cartridge 10. Moreover, as discussed above, the controller 500 can determine the weight of specimen and sufficiency thereof for test(s), such as by subtracting the weight of the salver 211 and the weight of the empty assay cartridge from the total determined weight of the salver 211 and the assay cartridge that includes specimen. In an embodiment, each assay cartridge 10 can be weighed while empty or unloaded (e.g., before the sample or specimen is added to the assay cartridge 10).

In an embodiment, as the salver 211 is suspended between the first support location 218 and another support location, the salver 211 can be generally vertically movable (e.g., to allow accurate weighing thereof). Hence, for example, to engage one or more actuators with the assay cartridge in the salver 211, the multi-test assay system 100 can secure the salver 211, such that the salver 211 is substantially stationary (e.g., relative to the base plate 130). In an embodiment, the upper portion 110 can move downward toward the base plate 130 of the lower portion and can clamp or secure the salver 211 and to the tray 210 relative therebetween.

For example, as the tray 210 together with the salver 211 move into the closed configuration, the spring-loaded lever 132 can pivot downward (e.g., from the position shown in FIG. 3A to the position shown in FIG. 3B) about a pivot point 133 in a manner that allows the salver 211 to be positioned above and supported by the spring-loaded lever 132 (e.g., the spring-loaded lever 132 can lift at least a portion of the salver 211 off the tray 211). Moreover, as the upper plate 111 moves downward and closer to the base plate 130, the salver 211 can be pressed downward and toward the base plate 130 and the tray 210 (e.g., such that the salver 211 and the tray 210 are substantially stationary relative to the base plate 130). In an embodiment, moving or urging the salver 211 downward can move or urge the spring-loaded lever 132 downward (e.g., such that the spring-loaded lever 132 pivots down about the pivot point 133).

In an embodiment, the salver 211 can push the spring-loaded lever 132 downward as the upper portion 110 applies downward force onto the salver 211. For example, the spring-loaded lever 132 can be biased, such that a downward force applied to the spring-loaded lever 132 by the salver 211 can push the spring-loaded lever 132 downward and allow the upper portion 110 to move or press the salver 211 downward (e.g., such that salver 211 is forced against the tray 210). In an embodiment, forcing or otherwise securing the salver 211 relative to the base plate 130 or relative to the lower portion can locate the salver 211 at a predetermined or selected location, such that one or more actuators can engage one or more corresponding cartridge controls on the assay cartridge. Moreover, forcing or otherwise securing the salver 211 relative to the base plate 130 can locate the salver 211 at a predetermined or selected location, such that the actuators can engage corresponding cartridge control and the light analyzer assembly can receive light from one or more selected portions of the assay cartridge for diagnosing one or more conditions of the biological material in the assay cartridge (e.g., to diagnose presence of one or more pathogens).

As described above, the assay cartridge together with the salver 211 can be weighted by the multi-test assay system 100 after the tray 210 is in a closed position. For example, the salver 211 and the assay cartridge can be suitably or sufficiently enclosed by one or more portions or enclosures of the multi-test assay system 100 to prevent user access thereto. For example, the salver 211 and the assay cartridge can be suitably or sufficiently enclosed to prevent users or bystanders from interfering with or affecting the weighing of the assay cartridge.

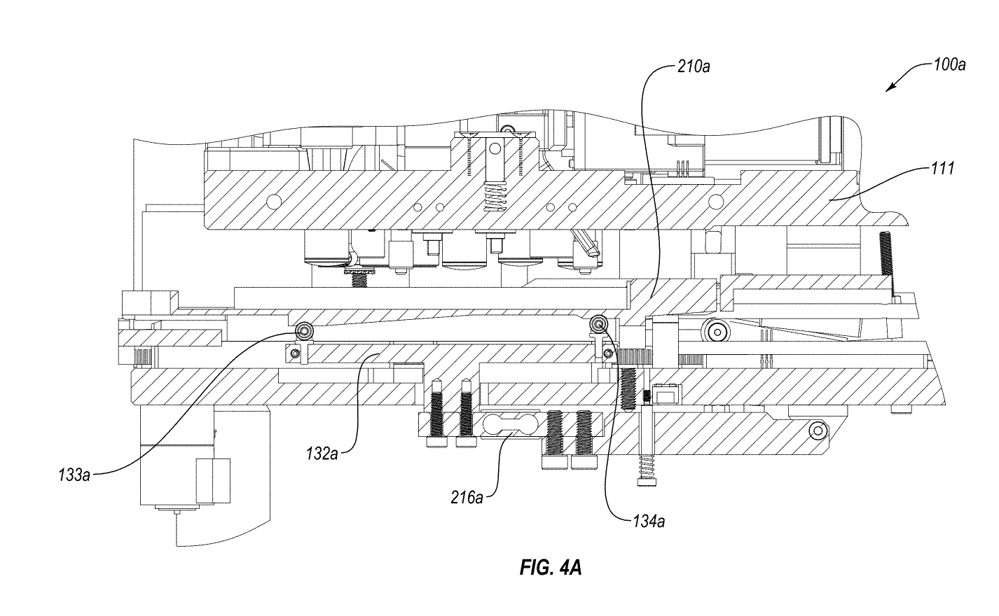

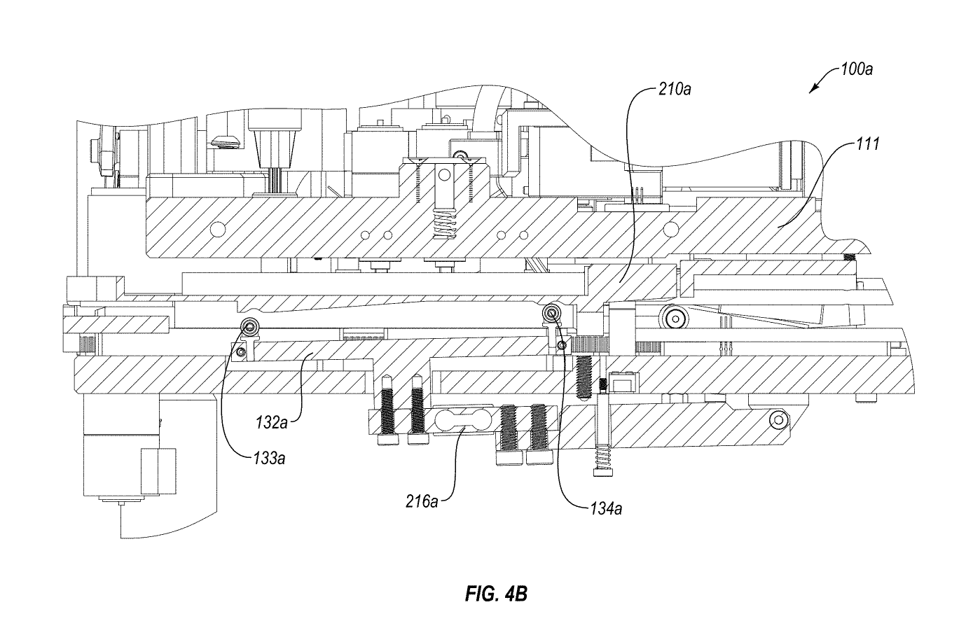

Generally, as mentioned above, the multi-test assay system 100 can include any number of suitable mechanisms or systems for weighing the assay cartridges (e.g., to determine the sufficiency of the weight or amount of the biological material provided with the assay cartridge. In an embodiment, the assay cartridge (e.g., together with the tray 210) can be positioned or suspended on a weighing platform that can be operably coupled to a sensing element (e.g., the weighing platform can be operably coupled to a load cell). FIGS. 4A and 4B illustrate partial side views of a multi-test assay system 100a according to an embodiment. Except as otherwise described herein, the multi-test assay system 100a can be similar to or the same as the multi-test assay system 100 (FIGS. 1A-3B). For example, the multi-test assay system 100a can include a tray 210a that can be similar to or the same as the tray 210 (FIGS. 1A-3B).

In an embodiment, the multi-test assay system 100a can include a weighing platform 132a that can be operably coupled to a load cell 216a. As described above, the load cell 216a can be operably coupled to a controller that can receive one or more signals therefrom. The signals received from the load cell 216a at the controller can be correlated by the controller to a weight positioned of the weighing platform 132a and the tray 210a positioned thereon. For example, as the tray 210a moves into a closed position, the tray 210a can slide over and can be positioned on the weighing platform 132a (e.g., the weighing platform 132a can include locator elements 133a, 134a that can position the tray 210a relative to the weighing platform 132a at a selected location). For example, the locator elements 133a, 134a can be rollers or wheels that can facilitate movement of the tray 210a relative to the weighing platform 132a, as the tray 210a moves from the open position to the closed position.

Moreover, in an embodiment, the tray 210a can include one or more divots or recesses that can accept at least a portion of the locator element 133a or locator element 134a therein, to locate the tray 210a relative to the weighing platform 132a (e.g., as shown in FIG. 4A). It should be appreciated that the tray 210a or weighing platform 132a can include any number of suitable elements or mechanisms to suitably locate to tray 210a on the weighing platform 132a. In any event, in an embodiment, when the tray 210a is in the closed position, the tray 210a can be located at a suitable location on the weighing platform 132a.

When the tray 210a is positioned on the weighing platform 132a (e.g., as described above), the tray 210a together with the weighing platform 132a can deflect the load cell 216a, thereby generating a signal that can be received by the controller. Specifically, for example, the controller can determine the weight of the tray 210a based at least in part on the signal received from the load cell 216a. In an embodiment, to determine the weight of the tray 210a with or without the assay cartridge, the controller can subtract the weight of the weighing platform 132a from the total weight (e.g., from the weight of the platform 132a, the tray 210a, the assay cartridge), to determine the weight of the tray 210a and the assay cartridge.

In an embodiment, as described above, the controller can determine the amount (e.g., the weight) of the biological material included with the assay cartridge by subtracting the weight of the empty assay cartridge from the total weight of the assay cartridge that includes the biological material. For example, to determine the weight of the assay cartridge, the controller can subtract the weight of the tray 210a from the weight of the tray together with the assay cartridge. As described above, to determine the weight of the biological material in the assay cartridge, the controller can subtract the weight of the assay cartridge without the biological material from the weight of the assay cartridge with biological material.

As discussed above, in an embodiment, to weigh the tray 210a and the assay cartridge, the tray 210a can be suspended on the weighing platform 132a, such that weighing platform 132a and tray 210a can move upward and downward substantially without impedance. To fix or secure the tray 210a relative to the base plate or to the upper portion 110 of the multi-test assay system 100a (e.g., such that the actuators of the multi-test assay system 100a can engage corresponding controls on the assay cartridge), the tray 210a can be pressed downward and can be secured relative to the base plate. In an embodiment, the tray 210a can be secured relative to the upper portion or relative to the lower portion of the multi-test assay system 100a, such that actuators of the multi-test assay system 100a can suitably engage corresponding controls on the assay cartridge or the light analyzer assembly can suitably receive target light from one or more targets on the assay cartridge.

It should be appreciated that the weight of the biological material provided with the assay cartridge can be input into the controller. For example, the assay cartridge together with the biological material can be weighed outside of the multi-test assay system, to determine the weight of the biological material. Moreover, in an embodiment, the assay cartridge may have one or more visually identifiable marking or locators for inspecting the amount of biological material present in the assay cartridge. Hence, for example, the sufficiency of the biological material can be visually examined. Additionally or alternatively, the multi-test assay system can include a visual detection system (e.g., similar to or the same as the test monitoring system) that can inspect or detect sufficiency of the biological material that is visible in the assay cartridge.

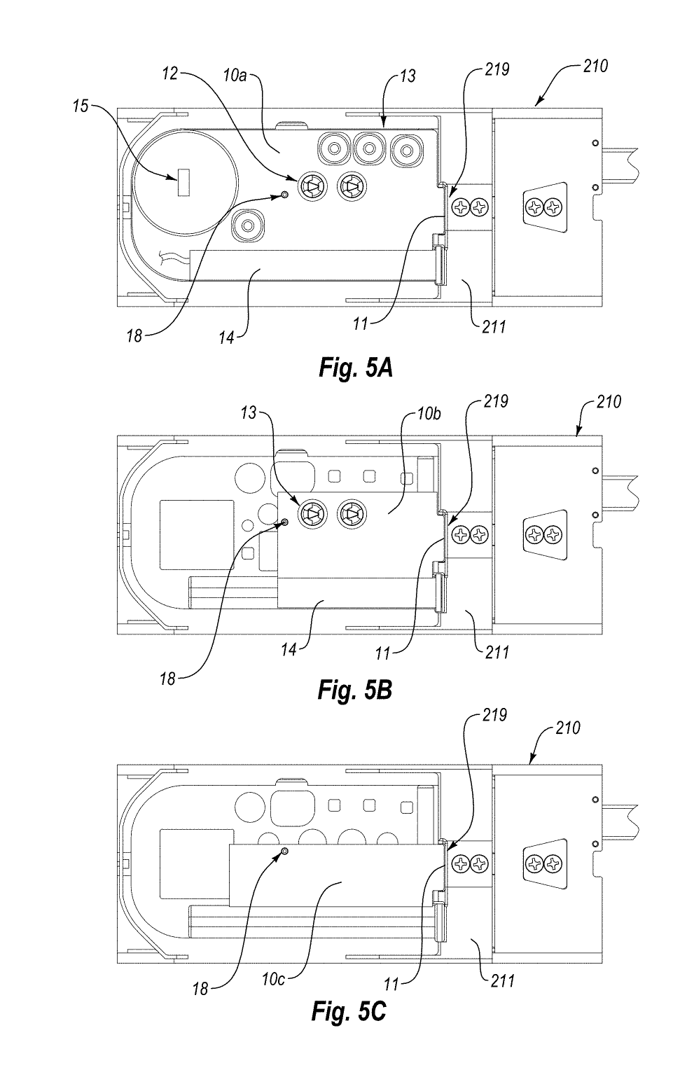

In an embodiment, the tray can locate the assay cartridge such that actuators of the multi-test assay system can suitably engage corresponding cartridge controls on the assay cartridge or the light analyzer assembly can suitably receive target light from one or more selected locations on the assay cartridge. Moreover, assay cartridges can vary from one embodiment to the next (e.g., depending on the specific testing for the biological material designated for the assay cartridge). FIGS. 5A-5C illustrate the tray 210 and the salver 211 locating three different types of assay cartridge (assay cartridge 10a in FIG. 5A, assay cartridge 10b in FIG. 5B, and assay cartridge 10c in FIG. 5C). For example, as described herein, the locating features of the multi-test assay system can location the various assay cartridges at suitable locations or orientations (e.g., relative to the actuators), such as the assay cartridges 10a, 10b, 10c (FIGS. 5A-5C).

In an embodiment, the salver 211 can be operably secured to or integrated with the tray 210 and can define a cavity or recess that can accommodate one or more assay cartridges therein. Moreover, the cavity that accommodates the assay cartridge can include one or more cartridge-locator elements that can be sized and configured to position and orient the assay cartridge relative to the tray 210 or relative to one or more elements or components of the multi-test assay system (e.g., relative to one or more actuators, light analyzer assembly, monitoring system, etc., which can interface with the assay cartridge). For example, the salver 211 can include a locator pocket 219, and assay cartridges can include a corresponding locator protrusion that can be positioned in the locator pocket 219 that can be defined by one or more walls of the salver 211.

For example, as shown in FIG. 5A, the assay cartridge 10a can include one or more locator features that can correspond to or interface with the cartridge-locator element(s) of the tray 210 (e.g., a protrusion 11 of the assay cartridge 10a can fit into the locator pocket 219) and can position and orient the assay cartridge 10a relative to the tray 210. Similarly, as shown in FIG. 5B, the assay cartridge 10b can include a protrusion 11b that can fit into the locator pocket 219 and can position and orient the assay cartridge 10b relative to the tray 210. Moreover, as shown in FIG. 5C, the assay cartridge 10c can include a protrusion 11c that can fit into the locator pocket 219 and can position and orient the assay cartridge 10c relative to the tray 210.

In an embodiment, the assay cartridges 10a, 10b, 10c can be different one from another (e.g., can be configured for different tests). For example, one, some, or each of the assay cartridges 10a, 10b, 10c can have different shape, size, etc., from another one or more of the assay cartridges 10a, 10b, 10c. As describe above, however, the assay cartridges 10a, 10b, 10c can include respective locator features, such as protrusion 11, that can predictably or selectively orient and position the each of the assay cartridges 10a, 10b, 10c relative to the tray 210.

It should be appreciated that the assay cartridges (e.g., assay cartridges 10a, 10b, 10c) can be positioned and oriented relative to the receptacle, (e.g., relative to the tray 210) by any number of suitable elements or components that can vary from one embodiment to the next. For example, the cartridge-locator elements can include one or more openings, and the locator features of the assay cartridge can include one or more posts (e.g., post 18 as shown on assay cartridges 10a, 10b, 10c (FIGS. 5A-5C)) that can be positioned inside the openings to locate and orient the assay cartridge relative to the tray 210. Additionally or alternatively, cartridge-locator elements of the receptacle, (e.g., cartridge-locator elements of the tray 210) can include one or more posts, and the locator features of the assay cartridge can include one or more openings sized and configured to accept the post(s) therein.

As described above, the assay cartridge can include one or more controls and the multi-test assay system can include one or more actuators that can interface with or operate the control(s) of the assay cartridge. For example, the assay cartridge 10a includes valves 12, burstable pouches 13, plunger channel 14, and mixer 15 (FIG. 5A). In an embodiment, one or more actuators can engage corresponding ones of the valves 12 and can operate the valves 12 to control flow of fluids in the channels of the assay cartridge 10a. For example, turning or rotating one or more of the valves 12 can permit or direct flow of one or more fluids to or from one or more selected portions of the assay cartridge 10a, as suitable for one or more tests. For example, the assay cartridge can include one or more containment features (e.g., channels), and the fluids can be contained and can flow therein. The fluid can contain or interact with the biological material to facilitate one or more tests. As described below in more detail, one or more actuators of the multi-test assay system can interface with and operate the valves 12 to test the biological material of the assay cartridge 10a.

In an embodiment, one or more additives can be added to the biological material to facilitate testing thereof. For example, the burstable pouches 13 (shown in FIGS. 5A and 5B) can contain one or more additives (e.g., dyes, particles, such as nanoparticles, antibodies, etc.). For example, as described below in more detail, one or more actuators can interface with one or more corresponding burstable pouches 13 to selectively release the additives thereof into one or more portions of the assay cartridge (e.g., as shown for assay cartridge 10a or assay cartridge 10b (FIGS. 5A-5b)).

In an embodiment, one or more actuators of the multi-test assay system can advance fluid to one or more locations in the assay cartridge. The fluid can include or interact with the biological material of the assay cartridge. For example, an actuator (e.g., a plunger) can be advanced in the plunger channel 14 (FIGS. 5A and 5B) in distal or proximal direction, to push or pull fluid in the assay cartridge (e.g., as shown for assay cartridges 10a, 10b (FIGS. 5A and 5B)). In an embodiment, distally moving the plunger in the plunger channel 14 can increase pressure in one or more channels of the corresponding assay cartridge 10a or 10b, thereby pushing the fluid in the corresponding assay cartridge 10a or 10b to flow away from the plunger and into one or more portions of the corresponding assay cartridge 10a or 10b. Conversely, proximally moving the plunger in the plunger channel 14 can decrease pressure in one or more channels of the corresponding assay cartridge 10a or 10b, thereby pushing the fluid in the assay cartridge to flow toward the plunger and into one or more portions of the corresponding assay cartridge 10a or 10b.

Moreover, as described above, the valves 12 (FIG. 5A) can direct the flow of fluid in the channels of the assay cartridge (e.g., of the assay cartridge 10a). Hence, one or more actuators of the multi-test assay system can operate the valves 12, such that as the plunger moves in the plunger channel 14, the fluid in the assay cartridge 10a can flow into one or more portions or channels of the assay cartridge 10a, as directed by the valves 12 (e.g., valves 12 can include multiple openings that can fluidly connect together two or more channels in the assay cartridge, such that the fluid flow is directed from a first channel into a second channel).

In an embodiment, testing the biological material of the assay cartridge can involve mixing or separating one or more portions of the biological material. For example, the assay cartridge (e.g., assay cartridge 10a) can include a mixer or separator that can be operated by an actuator of the multi-test assay system, as described above. It should be appreciated that assay cartridges can include any number of suitable cartridge controls that can interface with and can be operated by one or more corresponding actuators of the multi-test assay system.

Moreover, the cartridge controls can be positioned and oriented at predetermined or selected locations (e.g., relative to the cartridge-locator element, such as the locator pocket 219, and relative to the locator feature of the assay cartridge, such as the protrusion 11). Hence, for example, positioning any suitable assay cartridge at a selected or predetermined position relative to the receptacle (e.g., relative to the tray 210) can position and orient the controls of the assay cartridge relative to the actuators of the multi-test assay system, as described below in more detail. It should be also appreciated that assay cartridges can include no controls thereon, such as assay cartridge 10c (FIG. 5C).

Furthermore, for example, the assay cartridges can include on or more control areas that can interface with one or more actuators (e.g., without corresponding controls on the assay cartridge). As described below in more detail, one or more actuators can contact or can be positioned near the control areas to heat, cool, vibrate, etc., the material at the control areas (e.g., the biological material located at the control areas). Moreover, in an embodiment, the controls of the assay cartridge can include internal controls and can be located inside one or more cavities of the assay cartridge, and the actuators can interface or operate the control without direct contact therewith. For example, the controls can include magnetic or metallic elements (e.g., permanent magnets, metal wires or coils, etc.) that can interface with magnetic or electronic actuators of the multi-test assay system. In an embodiment, the actuators can induce heating, movement, rotation, or combinations thereof in the internal controls. For example, an actuator including a rotating magnetic field (e.g., a rotating permanent magnet or rotating electromagnet) can rotate a metallic or magnetic internal control of the assay cartridge (e.g., to stir the biological material).

In an embodiment, the internal controls can include release valves that can impede or prevent flow of fluid in the assay cartridge. For example, internal controls can include a wax valve (e.g., the wax valve can contain or prevent fluid flow). In an embodiment, the multi-test assay system can include an actuator configured to at least partially melt the wax, such as to allow the blocked fluid to flow from one portion of the assay cartridge toward another portion thereof.

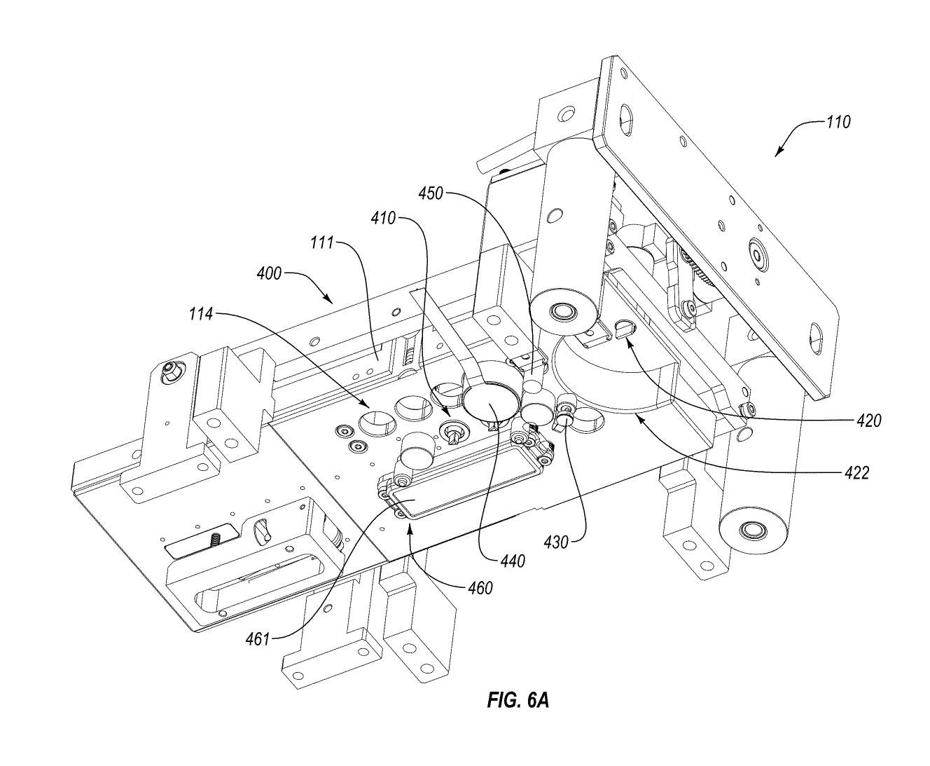

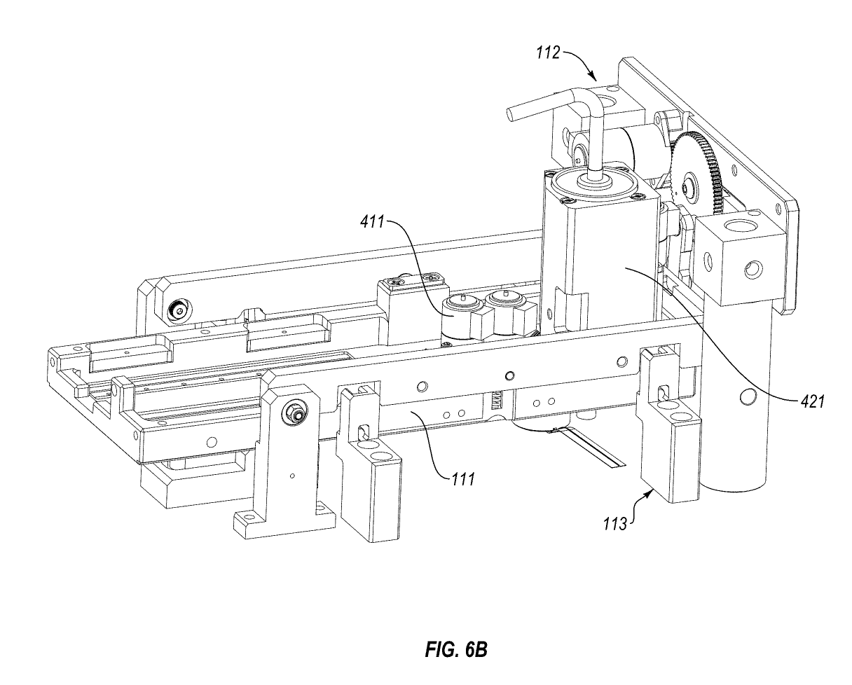

In an embodiment, one or more of the actuators can be positioned or operably coupled to the upper portion 110, as shown in FIGS. 6A and 6B. FIG. 6A is an axonometric view that shows a lower side of the upper portion 110 (e.g., the side facing toward the assay cartridge), and FIG. 6B is an axonometric view that shows an upper side of the upper portion 110. As described above, the upper plate 111 of the upper portion 110 can move downward and clamp or secure the assay cartridge together with the tray (e.g., to the base plate 130 (FIGS. 1A-1B)), such that the assay cartridge is located at a selected or predetermined position relative to the actuators of the multi-test assay system.

For example, the multi-assay test system can include a movement control 112 (FIG. 6B) that can advance the upper plate 111 of the upper portion downward (toward the assay cartridge) to the lowered position and upward (away from the assay cartridge) to the raised position. In an embodiment, the movement control 112 of the multi-test assay system can include a motor, a reduction gearbox, and a crank link connected to the reduction gear, such that rotation of the motor and corresponding rotation of the reduction gear moves the cam lever about a pivot point on the reduction gear, which is positioned at a selected distance from the axis of rotation of the reduction gear. The radial movement at the first end of the cam lever that is connected to the reduction gear can be translated to a linear movement at the opposing, second end of the cam level by allowing the cam lever to pivot at the end points thereof. In an embodiment, the second end of the cam lever can be pivotably connected to the upper plate 111, such that the rotation of the motor and of the reduction gear produce upward and downward movement of the upper plate 111 (e.g., relative to the tray and assay cartridge located thereon). It should be appreciated, however, that the upper plate 111 can be lowered and raised by any number of suitable mechanisms (e.g., pneumatic or hydraulic pistons, rack and pinion system, chain drive system, etc.), which can vary from one embodiment to the next.

In an embodiment, the multi-test assay system can include guides 113 that can guide the movement of the upper plate 111 (e.g., as actuated by the movement control 112). Generally, the guides 113 can include one or more channels that can receive one or more corresponding protrusions (e.g., dowels) of the upper plate 111. For example, the protrusions entering the channels in the guides 113 can be attached to or integrated with the upper plate 111. Additionally or alternatively, the upper plate 111 can be guided by guide pins and corresponding bushings (e.g., guide bushings can be mounted to or integrated with the upper plate 111 and the guide pins can be secured to the base plate of the multi-test assay system) or any other suitable guide configuration.

As described above, the upper portion 110 can include the actuator assembly 400. For example, the actuator assembly 400 can be operably coupled to or integrated with the upper plate 111. Hence, in an embodiment, the actuator assembly 400 can move toward and away from the assay cartridge together with the upper plate 111 (e.g., as the upper plate 111 moves between lowered and raised positions and shown in FIGS. 1C-1D)). Moreover, actuators of the actuator assembly 400 can engage or can be positioned to engage corresponding cartridge controls of the assay cartridge when the upper plate 111 moves downward or secures the assay cartridge together with the tray. In some embodiments, the actuators of the actuator assembly are activated responsive to one or more signals generated by the controller. For example, a controller can be configured to operate one or more actuators at one or more times depending on the data related to the identification of a specific assay cartridge. For example, a controller can be configured to stop operation of one or more actuators at one or more times depending on the data related to presence of a biological sample in an assay cartridge (e.g. if the data indicates an insufficient amount of the biological sample).

In an embodiment, the multi-test assay system can include valve actuators 410 that can rotate or turn valves (e.g., valves 12 (FIG. 5A)) to any suitable orientation. For example, the controller can direct rotation of the valve actuators 410 in a manner that turns or rotates the valves to a suitable orientation for one or more selected tests or test operations. As described below in more detail, the valve actuators 410 can include an engagement tip that is sized and configured to engage the valve of the assay cartridge, and can include a motor 411 (FIG. 6B) operably coupled to the engagement tip such that rotation of the motor can rotate the engagement tip, thereby turning or rotating the valve. In an embodiment, the engagement tip can be axially advanced to engage the corresponding valve on the assay cartridge (as described below).

Generally, the valve engagement tips of the valve actuators 410 can vary from one embodiment to another. In the illustrated embodiment, the valve engagement tips of the valve actuators 410 can have protrusions with approximately triangular cross-sections. For example, the valves of the assay cartridge can have engagement features that have complementary shapes to the shape of the valve engagement tips of the valve actuators 410, such that rotation of the valve actuators 410 can turn the valves when the valve engagement tips are engaged with the engagement features of the valve.

Moreover, in an embodiment, the multi-test assay system can include a mixer actuator 420 that can engage a mixer on the assay cartridge. For example, the mixer actuator 420 can include a mixer engagement tip that is sized and configured to engage a mixer control on the assay cartridge and a motor 421 that is operably coupled to the mixer engagement tip. Specifically, for example, rotation of the motor 421 (e.g., which can be actuated by one or more signals from the controller) can correspondingly rotate the mixer engagement tip and the mixer control on the assay cartridge.

Generally, the mixer engagement tip of the mixer actuator 420 can vary from one embodiment to another. In the illustrated embodiment, the mixer engagement tip of the mixer actuator 420 includes a protrusion that is shaped and configured to engage a slot- or recess-shaped engagement feature of the mixer control on the assay cartridge. As noted above, the mixer engagement tip of the mixer actuator 420 and the corresponding engagement feature of the mixer control on the assay cartridge can (but does not have to) be pre-oriented such that lowering the upper plate 111 together with the mixer actuator 420 engages the mixer engagement tip of the mixer actuator 420 with the mixer engagement feature on the assay cartridge.

In an embodiment, the assay cartridge can include a protruding container (e.g., as shown in FIG. 5A), and the mixer actuator 420 can be positioned in a recess 422 (e.g., recessed from the lower side of the upper plate 111) that can accommodate protruding container of the assay cartridge. Moreover, the mixer engagement tip can be positioned in the recess, such that the mixer engagement tip can engage the mixer control on the assay cartridge when the upper plate 111 is lowered toward or onto the assay cartridge. For example, the engagement tip and the corresponding feature(s) on the mixer control can be oriented at predetermined or selected orientations, such that lowering the upper plate 111 onto or toward the assay cartridge can engage the mixer engagement tip with the mixer control. In an embodiment, one or more portions of the mixer actuator 420 (e.g., the engagement tip thereof) can be axially movable or biased downward, toward the mixer engagement feature of the assay cartridge. For example, misalignment of the engagement tip of the mixer actuator 420 with the engagement feature of the assay cartridge can force or move the engagement tip of the mixer actuator 420 upward or away from the engagement feature; as the engagement tip of the mixer actuator rotates and finds or aligns with the engagement feature of the assay cartridge, the engagement tip can move downward and engage the engagement feature of the assay cartridge in the manner that rotation of the engagement tip of the actuator 420 can produce a corresponding rotation of the engagement feature or the mixer in the assay cartridge.

Also, as described above, assay cartridges can be configured without a mixer (e.g., one or more assay cartridge can be configured without a protruding container). Hence, for example, when the mixer engagement tip of the mixer actuator 420 is recessed below the lower side of the upper plate 111, the mixer engagement tip does not interfere with an upper surface of the assay cartridges that are configured without the protruding container.

As described above, assay cartridges can include one or more release valves (e.g., wax valves) that can impede or block flow of fluid(s) in the assay cartridge and can be selectively deactivated to allow the fluid flow. In an embodiment, a heater 430 can be positioned at or near a location of the wax valve(s) on the assay cartridge, such that activation of the heater 430 can at least partially melt the wax valve(s) to at least partially allow fluid flow at the location of the wax valve. For example, the controller can selectively activate the heater 430 based on suitable or desired fluid flow in the assay cartridge as may be suitable for one or more corresponding tests.

Generally, one or more portions of the assay cartridge can be heated or cooled by one or more corresponding actuators. In an embodiment, as described below in more detail, the actuators can include one or more thermoelectric cells (e.g., Peltier cells) that can selectively heat or cool corresponding portions of the assay cartridge. For example, the thermoelectric cell(s) can be positioned on the upper plate 111 and can contact one or more corresponding portions of the assay cartridge when the upper plate 111 moves downward toward the assay cartridge. Moreover, the multi-test assay system can include one or more temperature sensors (e.g., thermocouples, infrared sensors, etc.) that can sense the temperature of the assay cartridge and send one or more signals to the controller, which can correspond to the temperature sensed by the temperature sensor. In an embodiment, the controller can operate or direct operation of the thermal cell(s), such as to produce or maintain a selected temperature in one or more portions of the assay cartridge.

In an embodiment, the multi-test assay system can heat one or more elements or components located inside one or more chamber or channels of the assay cartridge. For example, the assay cartridge can include one or more magnetic elements (e.g., magnetic beads) located in one or more chambers or channels of the assay cartridge, and the multi-test assay system can include a heater-stirrer 440 that can heat the assay cartridge at the selected location and rotate a stir bar inside a chamber or channel of the assay cartridge, thereby heating and stirring one or more contents of the assay cartridge (e.g., fluid container biological material), such as to produce substantially even heating within of the contents. For example, the stirrer of the heater-stirrer 440 can include a permanent magnet can be rotated by a gearhead motor to spin an iron stir bar in the cartridge. Additionally or alternatively, the heater-stirrer 440 can generate alternating magnetic field to rotate the stir bar. As noted above, the multi-test assay system can include one or more temperature sensors, and the controller can regulate operation of the heater 440 in a manner that heater 440 produces a selected temperature or maintains a selected temperature in the assay cartridge.

Additionally or alternatively, the multi-test assay system can include a sonicator 450 that can contact the assay cartridge when the upper plate 111 moves toward the assay cartridge. The sonicator 450 can vibrate at one or more selected frequencies (e.g., at ultrasonic frequencies, such as 40 kHz) while in contact with one or more portions of the assay cartridge, and can, thereby, transfer energy to the assay cartridge. For example, vibrating the sonicator 450 in contact with one or more corresponding portions of the assay cartridge can disrupt or lyse the contents located in the portions (e.g., biological material located in the portions of the assay cartridge, which are subjected to sonication).

Additionally or alternatively, the multi-test assay system can include one or more push actuators (described below in more detail) that can press against one or more burstable pouches to burst or puncture the burstable pouches of the assay cartridge. For example, the upper plate 111 can include one or more openings, such as openings 114, and the push actuators can extend through the openings and selectively engage the burstable pouches of the assay cartridge. In an embodiment, the openings 114 or the push actuators can be located substantially in alignment with the corresponding burstable pouches of the assay cartridge (e.g., when the tray together with the assay cartridge are in a closed position, as described above). Hence, for example, one or more portions of the push actuators can move or extend through corresponding ones of the openings 114 to break, pierce, or burst the burstable pouches of the assay cartridge. For example, the controller can operate or direct operation of the push actuators, for example, as can be suitable for on one or more tests (e.g., the burstable pouches can include one or more additives that can be added to the biological material for testing). As described above, the multi-test assay system can include a light analyzer assembly. For example, the multi-test assay system can include a light-analyzer clamp 460 that can include a target-viewable area 461 that is at least partially transparent or translucent. In an embodiment, when the upper plate 111 moves downward and toward the assay cartridge, the light-analyzer clamp 460 can clamp or press against the assay cartridge, such as to substantially immobilize the assay cartridge relative to the target-viewable area 461 or actuators of the multi-test assay system.

In an embodiment, one or more portions of the surface or the entire surface of the target-viewable area 461 can be coated with a transparent or translucent material or film. For example, the transparent or translucent film can include one or more thermally-conductive materials, such as metals or metallic elements (e.g., the transparent film can include or comprise indium tin oxide (ITO)). In an embodiment, the thermally-conductive material can be heated to a suitable temperature. For example, the thermally-conductive material can be heated to prevent formation of condensation on the surface, to provide thermal control around the assay cartridge, etc.

As described below in more detail, the light analyzer assembly can project light onto one or more portions of the assay cartridge. In an embodiment, the light analyzer assembly can project pump light through the target-viewable area 461 and onto the assay cartridge, to illuminate one or more selected locations on the assay cartridge. Moreover, the light analyzer assembly (e.g., the spectrograph of the light analyzer assembly) can receive target light from one or more illuminated locations or targets on the assay cartridge.

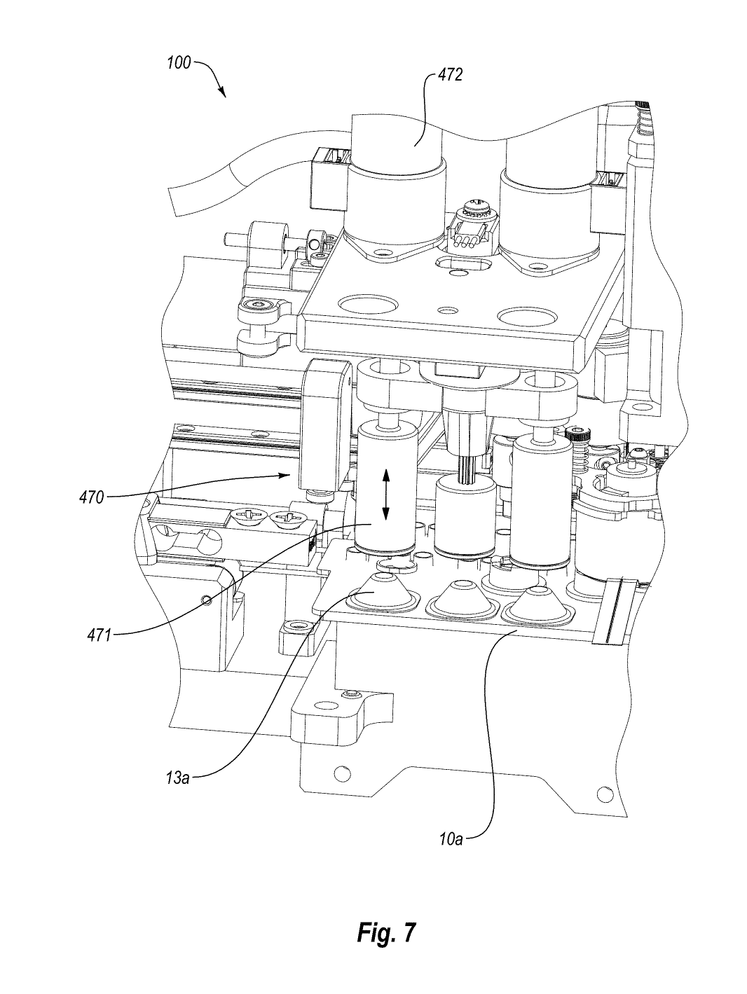

FIG. 7 is an axonometric cutaway view of the multi-test assay system 100, which shows partially exposed push actuators 470 according to an embodiment. In an embodiment, one, some, or each of the push actuators 470 can include a pouch engagement tip 471 and an actuation mechanism 472 operably coupled to the pouch engagement tip 471. The actuation mechanism 472 is positioned and configured to move the pouch engagement tip 471 downward (e.g., toward the assay cartridge 10a and toward the burstable pouches 13 (FIG. 5A)) or upward (e.g., away from the assay cartridge 10a (FIG. 5A)). For example, the push actuators 470 can be located in substantial alignment with the burstable pouches, such that when the pouch engagement tip 471 is lowered by the actuation mechanism 472, the pouch engagement tip 471 can contact and break or burst the corresponding one of the burstable pouches on the assay cartridge (e.g., to selectively release contents of the burstable pouches into channels of the assay cartridge).

Generally, the actuation mechanism 472 can vary from one embodiment to another. For example, the actuation mechanism 472 can be an electric motor, such as a step or servo motor, and the pouch engagement tip 471 can be operably coupled to the motor by one or more mechanisms configured to transform rotation of the motor into linear movement of the pouch engagement tip 471, as indicated with the arrows. In an embodiment, the push actuators 470 can include a screw operably coupled to or integrated with the rotary shaft of the motor and a corresponding threaded bushing operably coupled to or integrated with the pouch engagement tip 471, such that rotation of the screw can advance the threaded bushing together with the pouch engagement tip 471 toward or away from the burstable pouches of the assay cartridge. Additionally or alternatively, the actuation mechanism 472 can include a linear actuator, such as a pneumatic or hydraulic cylinder.

In any event, in an embodiment, the push actuators 470 can burst one or more burstable pouches of the assay cartridge. For example, the controller can operate or direct operation of the actuation mechanism 472 to move the pouch engagement tip 471 and selectively burst the burstable pouches. In an embodiment, the controller can select one or more of the burstable pouches to be at least partially emptied by the push actuators 470 depending on one or more requirements for the specific test(s).

Moreover, the multi-test assay system 100 can control the amount or rate of egress of the contents leaving burstable pouches (e.g., burstable pouch 13a), as may be suitable for the testing procedures or operations. For example, the controller can control movement of the pouch engagement tip 471 by operating or directing operation of the actuation mechanism 472. In an embodiment, the controller can control the speed of movement of the engagement tip 471 or the distance of movement of the engagement tip 471 (e.g., to control the rate of egress of the contents of the burstable pouch 13a or the amount of the contents that exits the burstable pouch 13a).

It should be appreciated that, as described above, the multi-test assay system can include any number of actuators that can be configured to perform any number of suitable operations on corresponding cartridge controls of the assay cartridge. In an embodiment, the assay cartridge can include a plunger channel that can receive a plunger therein. More specifically, the plunger channel can be fluidly connected to one or more channels in the assay cartridge, and the plunger can move in the distal and proximal directions to selectively increase or decrease pressure in the channels of the assay cartridge

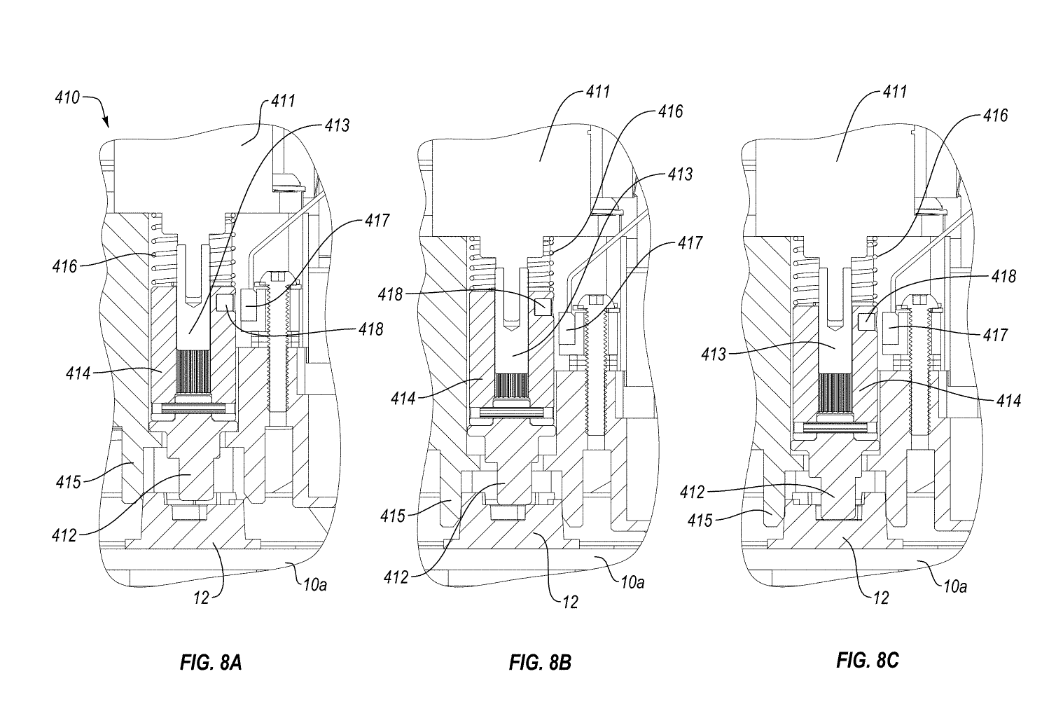

FIGS. 8A-8C illustrate a valve actuator 410, according to an embodiment. Specifically, FIG. 8A is a cross-sectional view of the valve actuator 410 in an unengaged position, FIG. 8B is a cross-sectional view of the valve actuator 410 in a partially engaged position, and FIG. 8C is a cross-sectional view of the valve actuator 410 in an engaged position. As mentioned above, in an embodiment, the valve actuator 410 can move toward the valve 12 of the assay cartridge together with the upper plate of the multi-test assay system. For example, the valve actuator 410 can include a valve engagement tip 412 operably coupled to the motor 411. When the valve actuator 410 moves into engaged position (as shown in FIG. 8C), the motor 411 can engage an engagement feature of the valve 12.

The valve actuator 410 can include a spline 413 that can be operably coupled to or integrated with the rotatable shaft of the motor 411 and a spline bushing 414 that can be operably coupled to or integrated with the valve engagement tip 412. The valve engagement tip 412 can be slidably coupled to the spline 413, such that the spline bushing 414 fits over the spline 413 and together with the valve engagement tip 412 can slide along the spline 413 toward and away from the engagement feature of the valve 12. For example, the valve actuators 410 can include a locator sleeve 415 that can locate the valve actuator 410 relative to the valves (e.g., the locator sleeve 415 can at least partially surround the outer periphery of the valve 12).

As the valve actuator 410 moves from the unengaged position (shown in FIG. 8A) to the engaged position (shown in FIG. 8C) or to the partially engaged position (shown in FIG. 8B), the locator sleeve 415 can be positioned to at least partially surround the valve 12. Under some operating conditions, the engagement feature of the valve 12 and the valve engagement tip 412 can be misaligned or can have different orientations relative to each other (e.g., as shown in FIG. 8B). Hence, under some operating conditions, when the valve actuators 410 are moved downward and into engagement with the valve 12, the valve engagement tip 412 can be pushed upward or away from the valve 12 (e.g., the valve engagement tip 412 together with the spline bushing 414 can move upward along the spline 413).

In an embodiment, the valve actuator 410 can include a biasing member 416 (e.g., a spring) that can urge the valve engagement tip 412 together with the spline bushing 414 toward valve 12 (e.g., after the valve engagement tip 412 together with the spline bushing 414 are pushed upward, as shown in FIG. 8B). For example, as the motor 411 rotates the valve engagement tip 412, the shape of the valve engagement tip 412 can come into alignment with the engagement feature of the valve 12, and the spline bushing 414 together with the valve engagement tip 412 can move downward to engage the engagement feature of the valve 12 (as shown in FIG. 8C). When the valve engagement tip 412 is engaged with the valve 12, as described above, rotation of the valve engagement tip 412 by the motor 411 can operate the valve 12, such as to direct or control flow of fluid in the assay cartridge 10a.

In an embodiment, the valve actuator 410 can include a sensor 417 (e.g., a contactless sensor, such as a Hall sensor, a contact sensor, etc.) that can detect a position of the valve engagement tip 412 and can detect (e.g., indirectly detect) engagement of the valve engagement tip 412 with the engagement feature(s) of the valve 12. For example, a locator 418 can be secured to one or more portions of the valve actuator 410 that move together with the valve engagement tip 412 (e.g., the locator 418 can be secured to the spline bushing 414 of the valve actuator 410). In an embodiment, when the upper plate is in the raised position, the locator 418 can be aligned with the sensor 417 (e.g., indicating a predetermined or selected home position of the actuator locator 418 relative to the locator sleeve 415, such as shown in FIG. 8A). When the upper plate together with the valve actuator 410 move downward toward the valve 12, if the valve 12 and engagement tip 412 have different orientations, which can prevent engagement of the valve engagement tip 412 with the valve 12, the valve engagement tip 412 can move upward, thereby misaligning the locator 418 relative to the sensor 417 (e.g., as shown in FIG. 8B). For example, the controller can receive a signal from the sensor 417 or locator 418, which can be related to the upward movement of the valve engagement tip 412 and failure of the valve engagement tip 412 to engage the valve 12.

As described above, the controller can operate or direct operation of the motor 411 of the valve actuators 410 to rotate the valve engagement tip 412, such that the valve engagement tip 412 aligns with and engages the engagement feature(s) of the valve 12. For example, based at least in part on the signals received from the sensor 417 based on the proximity of locator 418, the controller can determine that the valve engagement tip 412 is not engaged with the valve 12, hence rotation of the valve engagement tip 412 does not correspond to rotation of the valve 12 (e.g., the valve engagement tip 412 is rotated to align with the alignment features of the valve 12). Moreover, based at least in part on the signals received from the sensor 417 or locator 418, the controller can determine that the valve engagement tip 412 is engaged with the valve 12 and that the rotation of the valve engagement tip 412 produces rotation of the valve 12. For example, as described above, the valve engagement tip 412 can move downward to engage the valve 12, and the downward movement or positioning of the valve engagement tip 412 in engagement with the engagement feature(s) of the valve 12 after the movement can be detected by the sensor 417. Hence, in an embodiment, when the valve engagement tip 412 engages the valve 12 (e.g., as shown in FIG. 8C), the controller can determine successful engagement thereof based at least in part on one or more signals received from the sensor 417 or locator 418.

It should be appreciated that one, some, or all of the actuators can be activated or used in one or more tests or operations performed on the assay cartridge (e.g., based on one or more identifiers of the assay cartridge). Analogously, for one or more assays or tests, all of the actuators can remain inactive or unused in one or more tests or operations performed on the assay cartridge (e.g., based on one or more identifiers of the assay cartridge). As discussed above, the controller can determine the specific test(s) or operations to be performed on the assay cartridge and can activate or operate (directly or indirectly) the actuators suitable or required for performing the determined tests or operations.

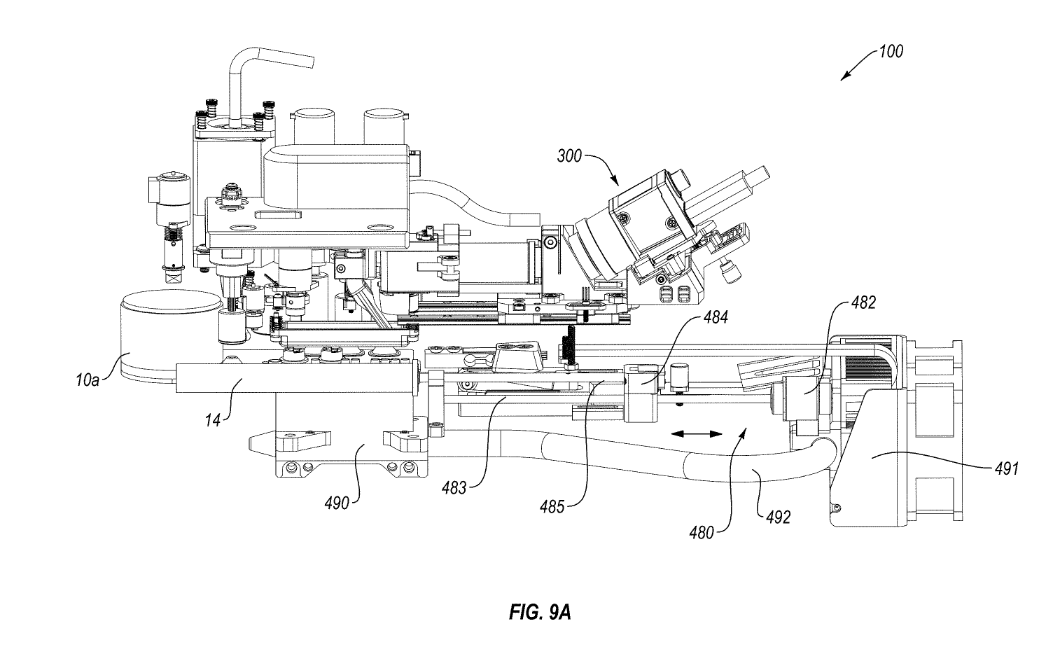

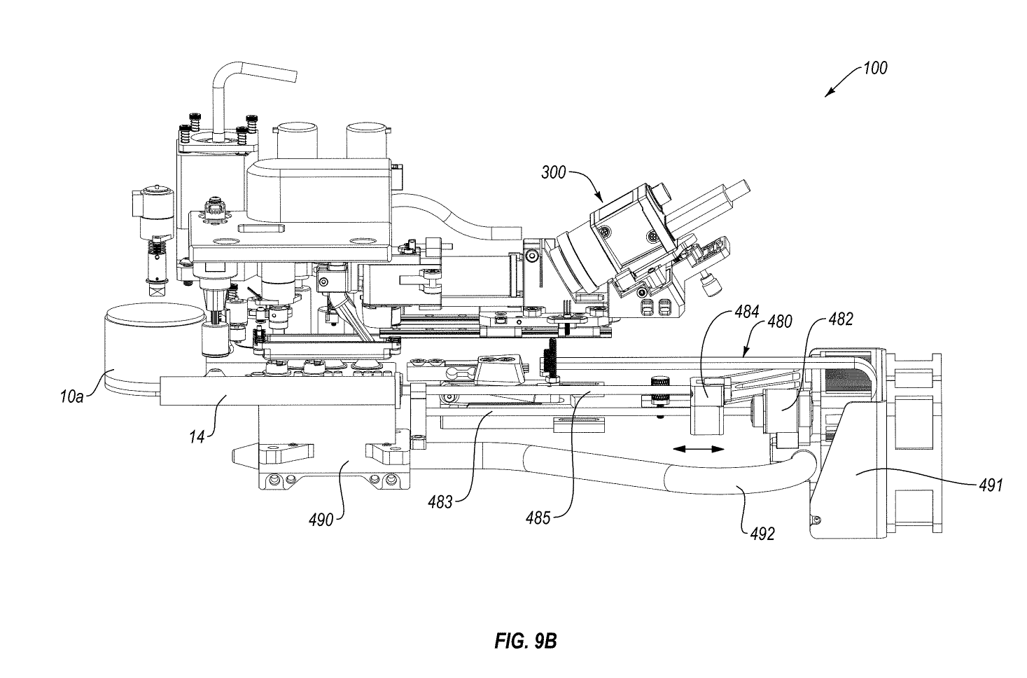

As described above, the assay cartridge can include a plunger channel, and the multi-assay test system can include a plunger actuatable to move in distal and proximal directions in the plunger channel to increase or decrease pressure in one or more channel in the assay cartridge. FIGS. 9A and 9B illustrate partial, exposed axonometric views of the multi-test assay system 100, according to an embodiment. In particular, some elements of the multi-test assay system 100 shown in FIGS. 9A and 9B have been removed to provide visibility of the plunger actuator 480. The plunger actuator 480 can move a plunger such that the plunger is advanced distally and retracted proximally in the plunger channel 14 of the assay cartridge 10a by an actuator 482, as described below in more detail. In an embodiment, the plunger can be integrated into the cartridge and the plunger actuator 480 can move the plunger responsive to one or more signals received from the controller.

In FIG. 9A, the plunger is in fully advanced position (e.g., where the plunger is positioned at the most distal position relative to the plunger channel 14). In FIG. 9B, the plunger 481 is in fully retracted position (e.g., where the plunger is positioned at the most proximal position). In an embodiment, the actuator 482 can be a motor, and the plunger actuator 480 can include a threaded shaft 483 operably coupled to or integrated with the rotary shaft of the actuator 482 and a threaded bushing 484. As the actuator 482 rotates the threaded shaft 483, the threaded bushing 484 moves in a distal direction or in a proximal direction (e.g., depending on the direction of the rotation of the actuator 482). Moreover, in an embodiment, the plunger actuator 480 can include an actuator shaft 485 operably coupled to the threaded bushing 484 and to the plunger that is located in the plunger channel 14, such that linear movement of the threaded bushing 484 produces a corresponding linear movement of the actuator shaft 485 and plunger. Hence, for example, the actuator 482 can move the plunger 481 in the distal and proximal directions relative to the plunger channel 14.

In an embodiment, movement of the plunger in the plunger channel 14 can increase or decrease pressure in the channels in the assay cartridge 10a, as described above. Increasing or decreasing pressure in the channels of the assay cartridge 10a can move the fluid in the assay cartridge 10a as may be suitable for one or more tests or test operations to be performed on the biological material of the assay cartridge. For example, the controller can control or direct operation of the actuator 482 such that the plunger moves in a manner that directs the flow of fluid in the assay cartridge 10a as can be suitable for one or more tests.

Also, as described above, one or more portions of the assay cartridge 10a can be cooled or heated by a thermoelectric cell. For example, the multi-test assay system 100 can include a thermoelectric cell 490 that can be positioned to contact the assay cartridge 10a or salver of the tray, such as to transfer heat from the thermoelectric cell 490 to the assay cartridge 10a and vice versa. In an embodiment, the thermoelectric cell 490 can be operably coupled to a heat exchanger 491. For example, an optional heat pipe 492 can connect the thermoelectric cell 490 to the heat exchanger 491. The heat exchanger 491 can produce a temperature differential in the heat pipe 492, such that the heat pipe 492 transfers heat from the thermoelectric cell 490 to the heat exchanger 491 (e.g., to improve cooling efficiency of the thermoelectric cell 490). The controller can operate or direct operation of the thermoelectric cell 490 in a manner that produces a suitable temperature at one or more portions of the assay cartridge 10a.

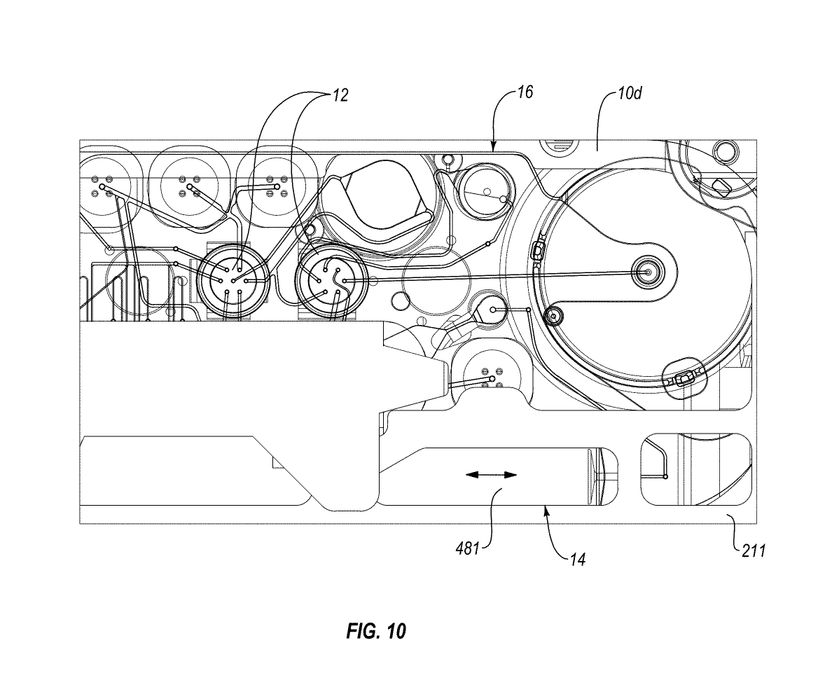

As described above, the assay cartridge can include one or more channels, and the multi-test assay system can control fluid flow in the channels. FIG. 10 is a bottom view of an assay cartridge 10d positioned on the salver 211, according to an embodiment. For example, as described above, the assay cartridge 10d can include a plunger channel 14 (e.g., similar to the assay cartridge 10a and assay cartridge 10b (FIGS. 5A-5B)), and the plunger of the plunger actuator can be at least partially positioned in the plunger channel 14 (e.g., such that movement of the plunger in the plunger channel 14 produces flow in one or more channels 16 of the assay cartridge 10d).

Generally, the assay cartridge 10d can have any suitable number of the channels 16 that can have any number of suitable configurations, which can vary from one embodiment to the next or from one test to the next. As described above, the flow in the channels 16 can be controlled by movement of the plunger, to increase or decrease pressure in the channels 16, thereby inducing flow in the first or second direction relative to the movement of the plunger 481, and by one or more valves 12. For example, as shown in FIG. 10, the valves 12 can place two or more of the channels 16 into fluid communication with one another, thereby allowing the fluid from one or more of the channels 16 to flow into other one or more channels of the channels 16. It should be appreciated that the multi-test assay system can position and orient the assay cartridge 10d and any other suitable or compatible assay cartridge (e.g., by interfacing the corresponding locator features, as described above), for example, in a manner that positions and orients the valves 12, channels 16, and plunger 481 at suitable locations and orientations to interface with the corresponding elements or components of the multi-test assay system (e.g., with the actuators and test monitoring system).

In an embodiment, the assay cartridge 10d can include or comprise at least partially transparent material (e.g., transparent polycarbonate). Hence, for example, the flow of fluid in the channels 16 can be visible or optically detectable. As described below in more detail, the multi-test assay system can include a test monitoring system that can detect or monitor fluid flow in the channels 16. For example, the test monitoring system can include at least one video camera, and the controller can receive one or more signals from the video camera, which can be correlated to the fluid flow in the channels 16. In an embodiment, at least in part based on the signals received from the video camera(s), the controller can determine whether the fluid in the channels 16 advances to suitable or selected locations or positions (e.g., as can be necessary for testing of the biological material in the assay cartridge 10d). For example, the controller can terminate testing upon detection of incomplete or insufficient flow or a failure of the fluid to flow to a selected location on the assay cartridge 10d. Similarly, based on one or more signals from the video camera, the controller can determine one or more of the flow of material from burstable pouches or the rate of flow therefrom, fluid movement in the assay cartridge, resulting from heating or cooling of the fluid, etc.

As described above, the tray together with the salver and the assay cartridge can move between open and closed positions. For example, when the tray is in the open position, the assay cartridge can be positioned on the tray, and together with the assay cartridge the tray can move into the closed position, where the multi-assay test system can analyze the biological material included in the assay cartridge. In an embodiment, the assay cartridge can be positioned over an opening or at least transparent window, such that at least a portion of the assay cartridge is positioned within the field-of-view of the test monitoring system.

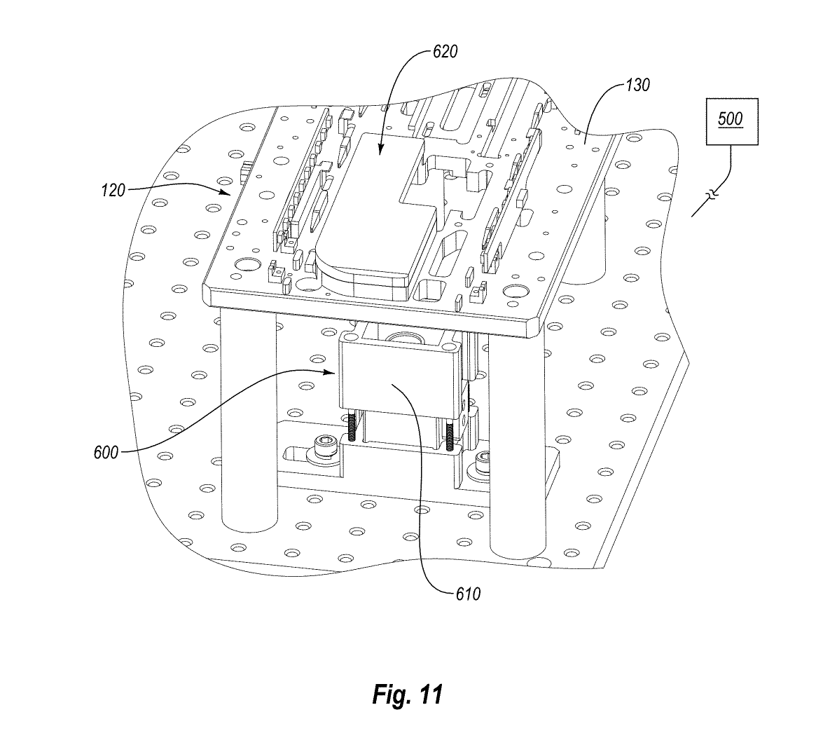

FIG. 11 is a partial axonometric view of the lower portion 120 of the multi-test assay system, according to an embodiment. In an embodiment, the video camera 610 of the test monitoring system 600 can be positioned below the base plate 130 of the lower portion 120. In the illustrated embodiment, the test monitoring system 600 includes a single video camera 610. It should be appreciated, however, that the test monitoring system 600 can include any suitable number of video cameras, which can vary from one embodiment to the next. For example, the test monitoring system 600 can include multiple video cameras that can be positioned closer to the assay cartridge (e.g., than a single video camera) or can have a narrower or smaller field of view than a single video camera (e.g., positioning multiple video camera closer to the assay cartridge can improve the quality of the images captured thereby).

For example, the base plate 130 can have an opening or a window that can be suitably sized and positioned relative to the closed tray and relative to the assay cartridge, such that one or more suitable portions of the assay cartridge are within the field-of-view of the video camera 610. In particular, for example, one, some, or each of the channels of the assay cartridge can be optically exposed to or within the field-of-view of the video camera 610 (e.g., the portions of the assay cartridge 10d shown as visible in FIG. 10 can be exposed to and within the field-of-view of the video camera 610).

In an embodiment, the test monitoring system 600 can include a window 620, and the tray together with the assay cartridge can be positioned above the window 620, such that one or more suitable portions of the assay cartridge are within the field-of-view of the video camera 610. Moreover, as described above, the video camera 610 can be operably coupled to the controller 500 and can send one or more signals thereto. For example, the controller 500 can determine the location of the leading edge or surface (e.g., an edge of a meniscus-shaped surface) of the flowing fluid flowing in the channel(s) of the assay cartridge. In an embodiment, the controller 500 can determine the location of the leading edge or surface of the fluid, based at least in part on the changes in reflection or shadows of the channels as the fluid advances in the channels of the assay cartridge. Hence, for example, the controller 500 can determine if the edge of the fluid flowing in the channel(s) of the assay cartridge has reached a selected or suitable location required or designated for a selected test being performed on the biological sample in the assay cartridge.

In an embodiment, the plunger can move to a selected position or location to advance fluid(s) in the channel of the assay cartridge. For example, as described above, the plunger can be advanced by an actuator that can include a stepper or servo motor and an encoder operably coupled thereto, to monitor rotation of the motor and corresponding advancement of the plunger (e.g., the controller 500 can receive one or more signals from the encoder and can adjust or direct rotation of the motor at least in part based on the signals received from the encoder). Under some operating conditions, the amount or location of fluid(s) in the channels of the assay cartridge can vary from one assay cartridge to another (including assay cartridges having the same general configuration). In an embodiment, the test monitoring system 600 can be configured to determine the location or position of the fluid(s), such that the controller 500 can operate the actuator of the plunger to advance the fluid(s) in the channels of the assay cartridge to suitable location(s). For example, the controller 500 can receive one or more signals from the video camera 610, can determine position or location of the fluid(s) in the channels of the assay cartridge based on the received signals (e.g., as described above), and can operate or direct operation of the plunger based at least in part on the signals received from the video camera or on the determined position or location of the fluid(s) in the channels of the assay cartridge.

In an embodiment, the controller 500 can store one or more images or signals received from the video camera 610. For example, the controller 500 can be configured to maintain or store a log of operations performed on the assay cartridge by the multi-test assay system. In an embodiment, the log can include one or more corresponding images (e.g., that can correspond to a state of the cartridge before or after a performed operation).

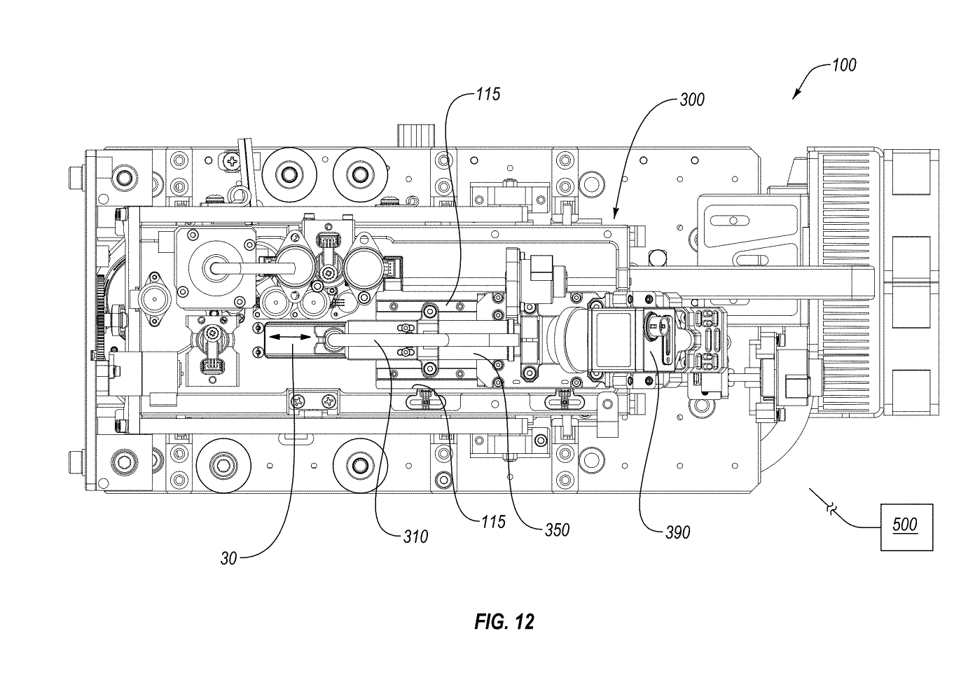

FIG. 12 is a top view of the multi-test assay system 100. As described above, the multi-test assay system 100 can include the light analyzer assembly 300 that can receive target light from the assay cartridge and can produce dispersed-target-light that can be directed to the image detector 390, such that the image detector 390 can produce one or more signals based on the dispersed-target-light. The signals produced by the image detector 390 can be sent to the controller 500. The controller 500 can determine the diagnosis for the biological material in the assay cartridge based on one or more signals received from the image detector 390.

In an embodiment, the image detector 390 can move relative to the upper plate (e.g., see upper plate 111 (FIGS. 1A-1B)) and relative to the assay cartridge in forward and backward directions 30, as shown with arrows. Hence, for example, the light analyzer assembly 300 can sample or receive target light from multiple selected locations on the assay cartridge. In an embodiment, the controller 500 can direct the light analyzer assembly 300 to move relative to the assay cartridge (e.g., in a linear direction) as shown in FIG. 12. In an embodiment, the light analyzer assembly 300 can be operably coupled to one or more actuators and one or more guides that can direct or control movement of the light analyzer assembly 300 along a generally linear path. For example, the multi-test assay system 100 can include guides 115 that can guide the light analyzer assembly 300 along the path as shown with arrows in FIG. 12.

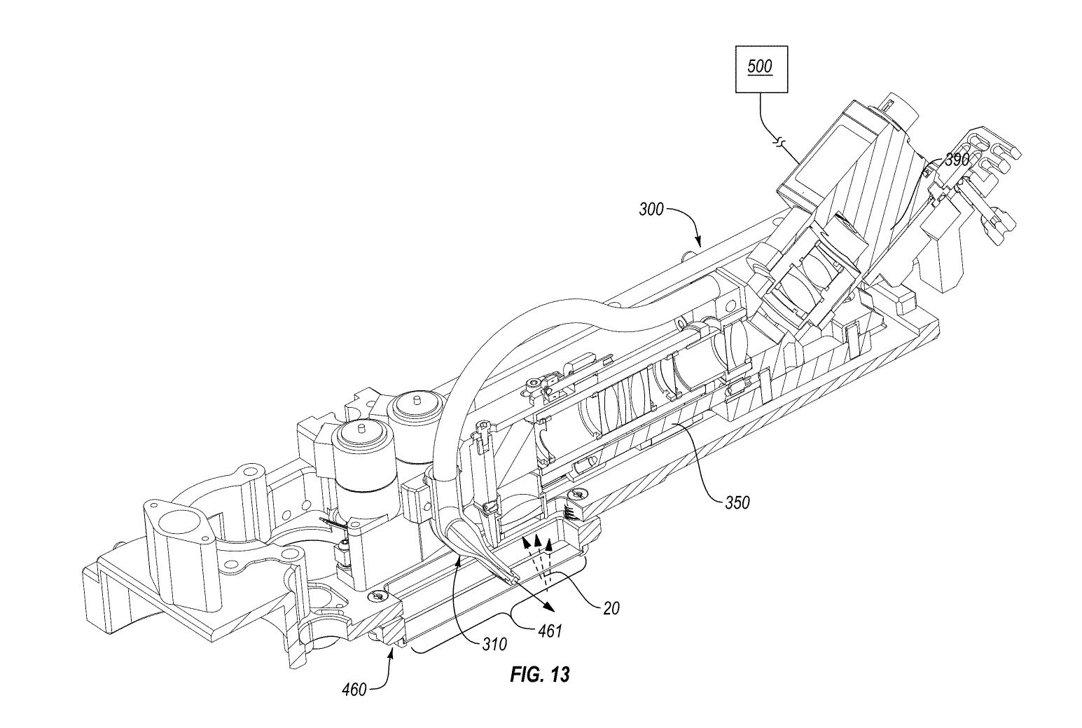

The light analyzer assembly 300 can be positioned at a selected location relative to the assay cartridge, such as to receive target light therefrom. For example, as shown in the partial axonometric cutaway of FIG. 13, total target light 20 from the selected location or targets on the assay cartridge can enter the spectrograph 350 through the target-viewable area 461 of the light-analyzer clamp 460. In an embodiment, the pump light assembly 310 can irradiate or expose the selected location on the assay cartridge to one or more wavelengths of pump light. For example, the light produced by the pump light assembly 310 can be selected to generate luminescence or otherwise generation of target light that is included in the total target light 20 from the selected location of the assay cartridge. As mentioned above, the total target light 20 generated at the assay cartridge can enter the spectrograph 350 and can be further processed thereby.

As described below in more detail, the spectrograph 350 can include one or more optical elements that can be configured to produce a dispersed-target-light at the output of the spectrograph 350. In an embodiment, the multi-test assay system can include the image detector 390 operably coupled to the output of the spectrograph 350. Moreover, the image detector 390 can be operably coupled to the controller 500 and can send one or more signals thereto, which can correspond to or can be at least in part based on the dispersed-target-light received at the image detector 390.

In an embodiment, at the selected location, the assay cartridge can include multiple targets. For example, each target can include one or more portions of channels of the assay cartridge, one or more strips, etc., that can include reacted biological material. Generally, the spectrograph 350 can transform the target light from one or more targets (e.g., to dispersed-target-light) and output the transformed light to the image detector 390, such that the image detector 390 can detect one or more wavelengths of the target light corresponding to respective targets at the selected location on the assay cartridge. For example, biological material can be reacted with one or more reactants, such that exposing the reacted biological material to selected wavelengths of the pump light generates target light of one or more selected or predetermined wavelengths, and the wavelengths of the target light can be associated with one or more results or indications of a presence or absence of a pathogen or a condition in the biological material.

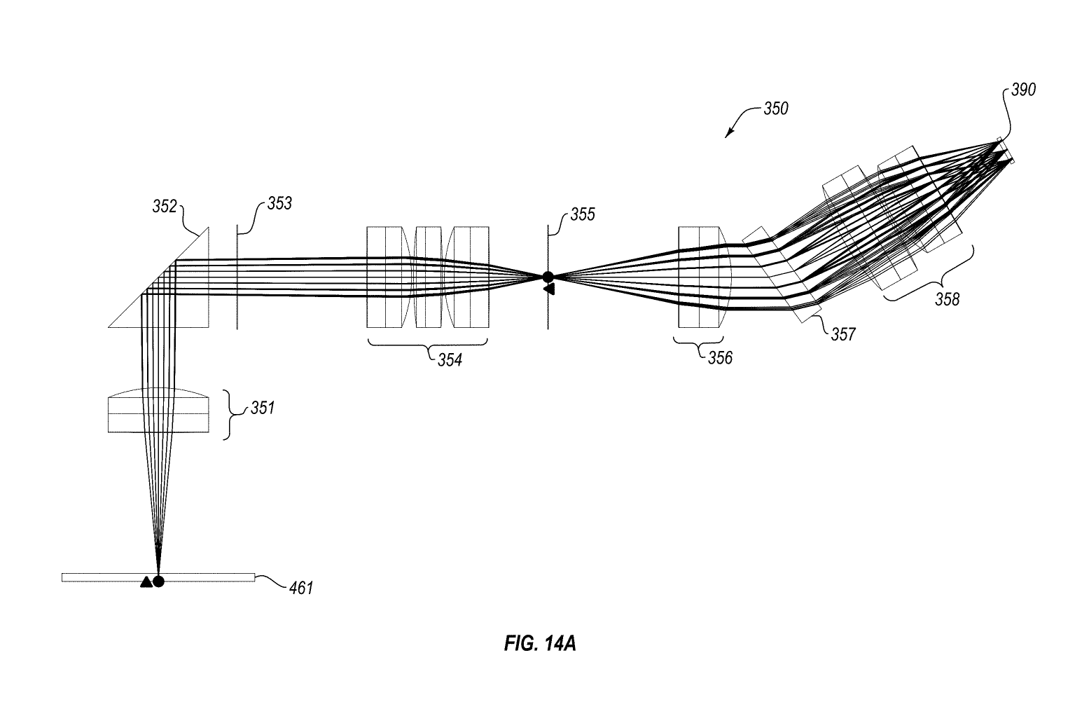

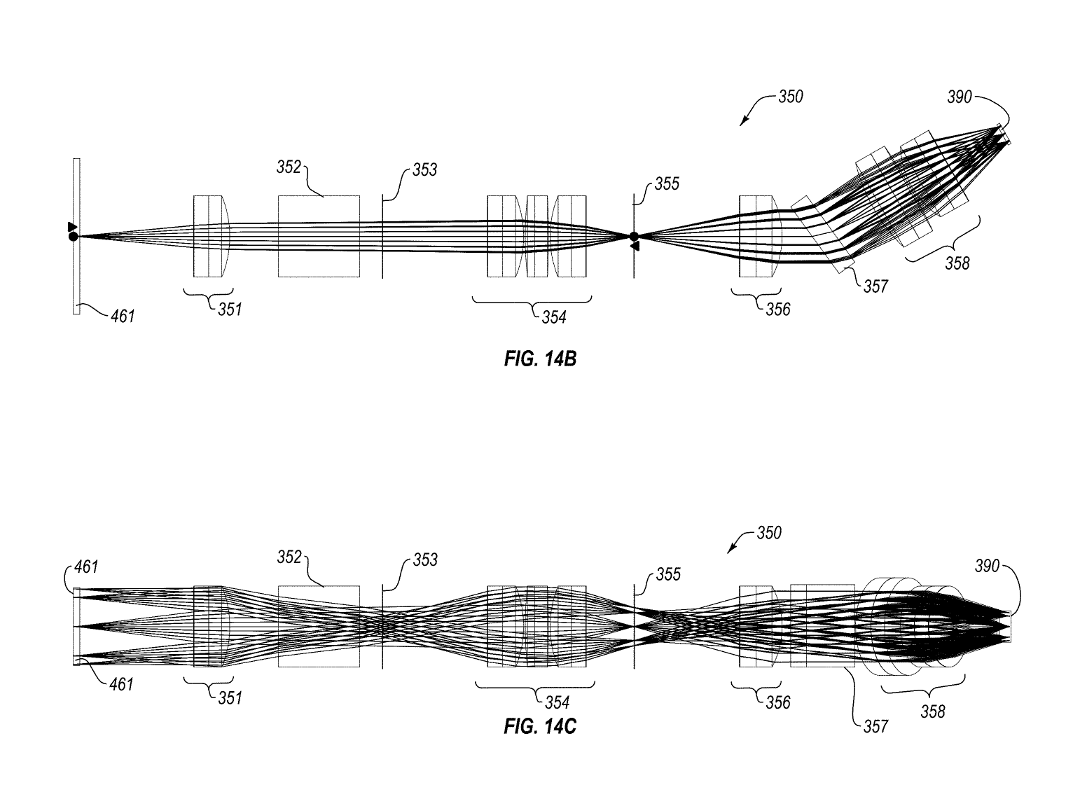

Generally, the spectrograph 350 can have any number of suitable configurations for transforming the target light and the total target light, which can vary from one embodiment to the next. FIGS. 14A-14C are schematic diagrams of the spectrograph 350 according to an embodiment. Specifically, FIG. 14A is schematic of the optical path from a side view of the spectrograph 350; FIG. 14B is a schematic side view of an unfolded optical path for light from a location on an assay cartridge and FIG. 14C is a schematic view of the unfolded optical path from a top view of the spectrograph 350.

FIG. 14A schematically shows how a point along the target ends up as a point image at the plane of the slit plate 355 and subsequently as a discrete point image for each discrete wavelength at the image detector 390. As described herein, the spectrograph 350 can disperse light and separate light wavelengths, such as to project different light wavelengths onto different portions or areas of the image detector 390. Specifically, for example, FIG. 14A shows the path of total target light after entering the spectrograph 350, as the light passes through the optical elements of the spectrograph 350. The spectrograph 350 can include collection optics and spectrographic optics. For example, the collection optics can collect the total target light, that includes the target light and noise light, entering the spectrograph 350 and prepare the target light for dispersion. In an embodiment, the spectrographic optics can create individual images of the separate wavelengths from separate test areas at the selected location on the assay cartridge and project the individual images on the image detector 390 of the light analyzer assembly 300, as described below in more detail.

For example, the spectrograph 350 can include a first collimating lens 351 positioned behind the target-viewable area 461. The first collimating lens 351 can be positioned at a suitable distance from the target zone or the target-viewable area 461 to clear the various cover windows or other structures or obstacles as well as allow enough clearance for the pump light from one or more light sources (e.g., the first collimating lens 351 can be positioned at approximately at one focal length from the target(s) at the selected location)). In an embodiment, the first collimating lens 351 can be configured to capture a suitably large cone of the total target light (at the selected location of the assay cartridge) and redirect the target light behind the first collimating lens 351.

Generally, the spectrograph 350 can have any suitable shape (e.g., as can be suitable for a specific configuration of the multi-test assay system) that can vary from one embodiment to another. In the illustrated embodiment, the spectrograph 350 is generally L-shaped. For example, the L-shaped spectrograph 350 can facilitate lower overall height of the multi-test assay system. Hence, in an embodiment, the spectrograph 350 can include a redirecting optical element 352 (e.g., a prism, a beam splitter, a mirror, etc.) that can change the direction of the target light. For example, the redirecting optical element 352 can include one or more of a prism, or one or more mirrors. As illustrated in FIG. 14A, the target light passing through the redirecting optical element 352 can be at approximately 90° relative to the target light exiting the first collimating lens 351 and entering the redirecting optical element 352. In an embodiment, the spectrograph 350 can include one or more apertures 353 positioned behind the first collimating lens 351 (e.g., at least some of the light exiting the redirecting optical element 352 can enter the aperture 353). For example, the aperture 353 can be positioned one focal length behind the first collimating lens 351 and can limit or select the size of the cone of rays of the target light that can be captured by the spectrograph 350. That is, the rays outside of the selected cone can result in collimated rays that project from the redirecting optical element 352 positioned before or outsize of the aperture 353, which can block some of the collimated rays. It should be appreciated that the aperture can be positioned at any other suitable location, such as before the first collimating lens 351.

In an embodiment, the redirecting optical element 352 of the spectrograph 350 can be configured to direct a portion of the target light toward the aperture 353 and a portion of the target light in another direction (e.g., the redirecting optical element 352 can direct 90% of the target light toward the aperture 353, and 10% toward another element or component). For example, the multi-test assay system can include or can be operably coupled to an imager or test monitoring system (e.g., as described below in more detail) that can be configured to have a field of view or receive light from suitable portions of the assay cartridge for monitoring fluid flow, detecting leaks, detecting bubbles in the fluid, and otherwise visually monitoring the processes in the assay cartridge). The redirecting optical element 352 can be configured to direct at least a portion of the target light to the imager that can be operably coupled to the controller that can receive one or more signals from the imager; responsive to the signals received at the controller from the imager, the controller can determine location of the fluid edge in the assay cartridge, presence or absence of bubbles in the fluid, flow speed, leaks, etc., in the assay cartridge.

Moreover, in an embodiment, the controller can determine one or more wavelengths from the target light, which can correspond to a determination of presence or absence of one or more markers in the biological material tested in the assay cartridge. For example, the controller can compare the wavelengths determined based on the signals received from the imager to the wavelengths determined based on the signals received from the image detector 390 (e.g., as described herein).

In an embodiment, the spectrograph 350 can include one or more first reimaging lenses 354 positioned behind the aperture 353, such that light exiting the aperture 353 can enter the first reimaging lenses 354. For example, the first reimaging lenses 354 can collectively focus the rays exiting the aperture 353 onto a spot in a selected plane (e.g., at a selected location behind the first reimaging lenses 354). For example, the spectrograph 350 can include a slit plate 355 that can be positioned at a selected distance behind the spectrograph 350, and the first reimaging lenses 354 can focus the rays exiting the aperture 353 on a plane of the slit plate 355.

The slit plate 355 can define or limit the field-of-view of the spectrograph 350. For example, the slit in the slit plate 355 can be sized such that light outside of the targets or noise light at the selected location misses the slit and is blocked by the slit plate 355. Moreover, in an embodiment, the focal length of the first collimating lens 351 can be two times greater than the focal length of the first reimaging lenses 354 (e.g., the distance from the first reimaging lenses 354 to the slit plate 355), which can produce a 1:2 magnification of the light. For example, for any point along each of the targets, the cone of rays focused at the plane of the slit plate 355 can have twice the apex angle as the cone of rays of the collected target light.

As shown in FIGS. 14A-14C, if the re-imaged cone of light (behind the slit plate 355) had a larger apex angle (i.e., than shown in FIGS. 14A-14C), the light can spill off the edges of the elements of the spectrograph 350. For example, such light can be lost or end up passing through the system as noise and can produce stray offset light on the image detector 390. Moreover, the 1:2 magnification can result in a size of any spot imaged at the plane of the slit plate 355 that is half the size of the target spot being measured. That is, for example, a slit that is 85 μm wide will pass light coming from a 170 μm wide region at the target.

In an embodiment, the collection optics (e.g., the first collimating lens 351, redirecting optical element 352, aperture 353, first reimaging lenses 354) converge the rays or ray bundles towards the optical axis when they come to a focus at the plane of the slit plate 355. As the light passes through the slit, the light passes through the center of the subsequent optical elements. Hence, for example, such configuration can facilitate keeping the light inside the elements in the spectrograph 350 and can facilitate creating even response with low vignetting across the entire width of each of the targets.

In an embodiment, the spectrograph 350 can include a second collimating lens 356 positioned behind the slit plate 355. Hence, for example, the collected target light that passes through the slit of the slit plate 355 can be collimated (e.g., such that the rays passing out of the second collimating lens 356 can be generally parallel to one another). In an embodiment, a dispersion element 357 (e.g., a diffractive lens) can be positioned behind the second collimating lens 356.

In particular, for example, from the collection optics, the collected total target light can enter the spectrographic optics of the spectrograph 350, which can disperse the total target light in a manner that produces dispersed-target-light that can be projected onto the image detector 390. In an embodiment, the dispersion element 357 can produce dispersed-target-light from the collected total target light passing therethrough. It should be appreciated that the spectrograph 350 can include any number of suitable optical elements configured to diffract or disperse the collected total target light (e.g., the dispersion element 357 can include lenses or flat windows with transmission grating or with reflection grating, elements with holographic patters, prisms, etc.).

For example, the dispersion element 357 can includes lenses that have a grating formed by polymer deposited on glass at 830 lines/mm. Generally, the line count that forms the grating can vary from one embodiment to the next. For example, the line count can be selected so that the wavelengths diverge suitable enough and the spectrum can cover a selected portion of the image detector 390 (e.g., the entire image detector 390). It should be appreciated that the grating on the diffraction element 357 can be formed with any number of suitable methods or arrangements that can vary from one embodiment to the next (e.g., the dispersion element 357 can have an etched grating).

In an embodiment, the dispersion element 357 can be oriented at non-parallel angle relative to the second collimating lens 356 (e.g., optic axis of the dispersion element 357 can be oriented at a non-parallel angle relative to the optic axis of the second collimating lens 356 or of the collection optics). In an embodiment, when the dispersion element 357 is removed from the spectrograph 350, the second collimating lens 356 can be positioned and configured to produce a 1:1 image from the slit of the slit plate 355 on the image detector 390. When the dispersion element 357 is positioned behind the second collimating lens 356, the different wavelengths of light can be the main 1^{st} order beam to disperse, so that each wavelength can be still collimated but can propagate at a different angle relative to the optical axis.

The dispersion element 357 can be tipped or angled relative to the second collimating lens 356 (e.g., to increase the optical power going into the 1^{st} order diffracted beam or reduce the power in both the straight through 0^{th} order beam as well as any other higher order diffraction beams). In an embodiment, the tipping angle of the dispersion element 357 can be selected in a manner that maximizes the optical power going into the 1^{st} order diffracted beam or minimize the power in both the straight through 0^{th} order beam as well as any other higher order diffraction beams. For example, the tipping angle of the dispersion element 357 can vary from one embodiment to the next and can be determined experimentally.

In an embodiment, the image detector 390 can be oriented in a manner that positions the plane or surface of the sensor generally parallel to the dispersion element 357 or perpendicular to the rays of dispersed-target-light projected onto the image detector 390. In an embodiment, the relative positions and angles of the second collimating lens 356, dispersion element 357 and image detector 390 can be selected or optimized to intercept the 1^{st} order of the dispersed-target-light and image such that selected wavelengths or a range of wavelengths fit onto the image detector 390. For example, the second collimating lens 356, dispersion element 357, and image detector 390 can have relative positions and orientations that fit the wavelengths from 450 nm to 700 nm onto the image detector 390. Moreover, in an embodiment, the spectrograph 350 can include one or more dispersed-light-reimaging lenses 358 that can intercept the dispersed-target-light and direct dispersed-target-light to the image detector 390 (e.g., without vignetting).

In an embodiment, one or more of the first collimating lens 351, first reimaging lenses 354, second collimating lens 356, dispersion element 357, or dispersed-light-reimaging lenses 358 can include achromatic lenses. For example, as compared to single-element lenses, achromatic lenses can improve imaging for all wavelengths and across the field-of-view of the spectrograph 350. Under some operating conditions, achromatic lenses can help reduce or minimize geometric aberrations or can help improve focus into the corners. Additionally or alternatively, one, some, or each of the first collimating lens 351, first reimaging lenses 354, second collimating lens 356, dispersion element 357, or dispersed-light-reimaging lenses 358 can be coated with one or more coat layers (e.g., with an antireflection coating). For example, an antireflection coating can facilitate improved total optical throughput through the spectrograph 350. Also, antireflective coatings can reduce or minimize back-reflection of the light passing through the spectrograph 350, which can could otherwise generate stray offset light that may be projected onto the image detector 390 (e.g., in a manner that can contribute an offset to the measurements of the signal light).

In an embodiment, one, some, or each of the first collimating lens 351, first reimaging lenses 354, second collimating lens 356, dispersion element 357, or dispersed-light-reimaging lenses 358 can have blackened edges. For example, blackening the edges of one, some, or each of the first collimating lens 351, first reimaging lenses 354, second collimating lens 356, dispersion element 357, or dispersed-light-reimaging lenses 358 can reduce the likelihood of stray light. For example, the edges of the one, some, or each of the first collimating lens 351, first reimaging lenses 354, second collimating lens 356, dispersion element 357, or dispersed-light-reimaging lenses 358 can be blackened with black paint (e.g., black enamel paint).

As described herein, the spectrograph 350 may include any suitable dispersion element 357. In the illustrated embodiment, the dispersion element includes at least one diffractive element, such as a grating. In additional or alternative embodiments, the dispersion element 357 may include at least one refractive element, such as one or more of a refractive lens or a prism.

Generally, the image detector 390 can include any number of suitable sensors or cameras. In an embodiment, the image detector 390 can be a camera that includes a CCD sensor (e.g., acA1 light analyzer assembly 300—30 um camera produced by Balser that has a monochrome Sony ICX445 CCD sensor that has 1296×966 pixels with a total size of 4.86×3.62 mm). Alternatively, the image detector 390 can include a suitable CMOS sensor.

As described above, the image detector 390 can be operably coupled to a controller that can receive signals therefrom. For example, the rays of the dispersed-target-light can be projected onto the image detector 390, such that selected wavelengths of the dispersed-target-light are projected to selected or predetermined locations on the image detector 390 (e.g., along a first axis). Moreover, as described above, the spectrograph 350 can receive target light from multiple targets on the assay cartridge. In an embodiment, the dispersed-target-light can be projected to selected or predetermined locations of the image detector 390, which can correspond to or can be identifiable with the corresponding target (e.g., the dispersed-target-light can be projected onto the image detector 390 at distinct locations along a second axis, such that dispersed-target-light from a first target is spaced apart from the dispersed-target-light from the second target).

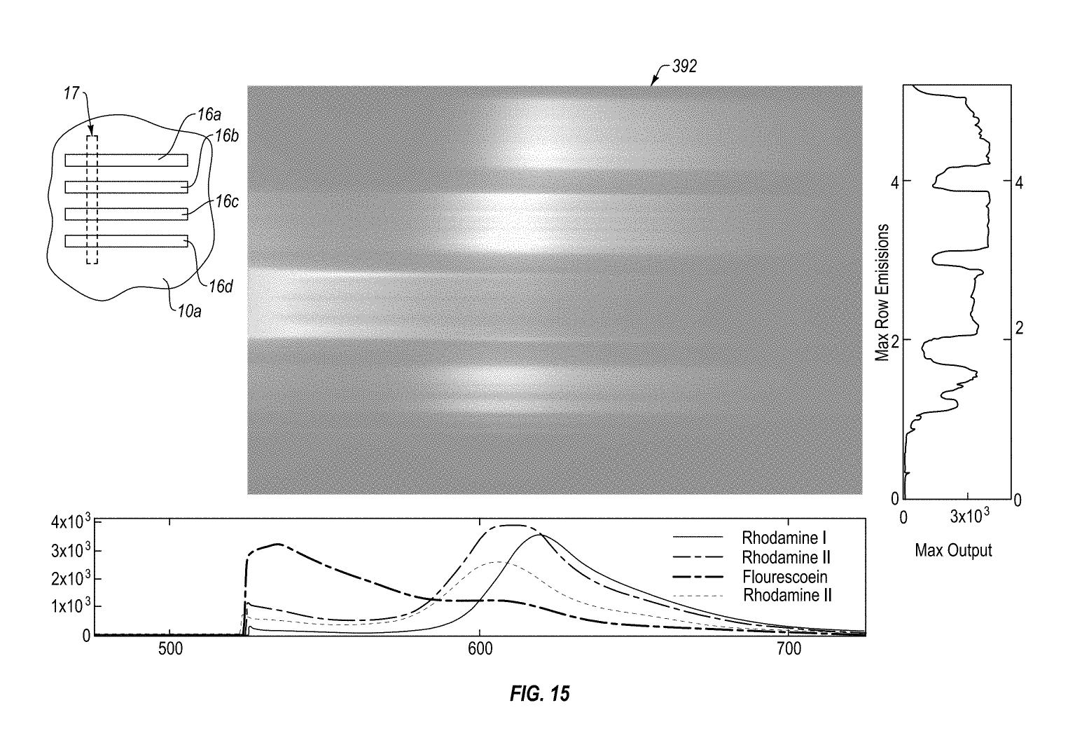

FIG. 15 illustrates a working example image 392 detected by the image detector based on the dispersed-target-light projected to the image detector by the spectrograph that received target light from four targets with pump light from the light sources and noise light subtracted, according to an embodiment. FIG. 15 shows the selected location 17 of the channels 16a, 16b, 16c, 16d, which define the targets interrogated by the spectrograph on the assay cartridge 10a. In an embodiment, the spectrograph can produce dispersed-target-light from the total target light received at the selected location 17 of the assay cartridge 10a and can project the dispersed-target-light to selected locations of the image detector, as shown in the example image 392. For example, the dispersed-target-light can be projected to selected locations of the image detector such that the dispersed-target-light that corresponds to each target is projected to a distinct location of the image detector and can be identified by the controller.

At each location corresponding to each of the targets on the image detector, the dispersed-target-light can exhibit different intensity along a first axis, as shown in a horizontal graph. For example, a higher intensity areas or segments can correspond to a selected or predetermined wavelength of the target light received from the corresponding target. That is, the spectrograph can disperse the target light in a manner that the wavelength of the target light that corresponds to a target that is projected at a selected location onto the image detector.

Moreover, the light can be distributed at one or more locations spaced along a second axis (e.g., vertically spaced, as shown in FIG. 15), and the one or more locations of the light projected onto the image detector can correspond to the one or more targets. For example, as shown in FIG. 15, the four targets defined by corresponding portions of the channels 16a, 16b, 16c, 16d at the selected location 17 can correspond to the four locations shown in the example image 392, at which the light projected onto the image detector is distributed.

As shown in FIG. 15, the light projected onto the image detector can have some bleed over to locations near the selected or predetermined location for the specific wavelength. In an embodiment, the controller can determine the wavelength of the target light based at least in part on the location on the image detector (e.g., along the second axis and corresponding to the location for the specific target) that has the highest intensity of light. Moreover, as described above, the controller can correlate the wavelength determined by the controller to one or more indications or diagnoses for the biological material in the assay cartridge.

Moreover, based on the signals received from the image detector, the controller can determine or distinguish the intensity of light at one or more wavelengths. For example, the image detector can be configured to modulate the signal received by the controller, such that the controller can determine the intensity of light projected onto the image detector. Moreover, in an embodiment, the controller can correlate the determined intensity (e.g., at one or more specific wavelengths) to a value or diagnoses. In an embodiment, the controller can correlate the intensity of light received at the image detector to a quantitative measurement of a pathogen.

As described above, the targets on the assay cartridge can be illuminated by one or more light sources (e.g., by pump light), such that the target light is generated from each of the targets. Moreover, the target light can correspond to one or more indications or diagnoses for the biological material in the assay cartridge. In an embodiment, the light analyzer assembly can be advanced along the targets, such as to sample one, some, or each of the targets at multiple selected locations or to receive target light from multiple selected locations of the targets. For example, the wavelengths determined from the selected locations can be compared one to another to determine an average wavelength or to verify accuracy of the determination of the wavelength for each of the selected locations at one, some, or each of the targets. Hence, for example, the controller of the multi-test assay system can compare the signals received from the image detector among the multiple selected locations on the assay cartridge.

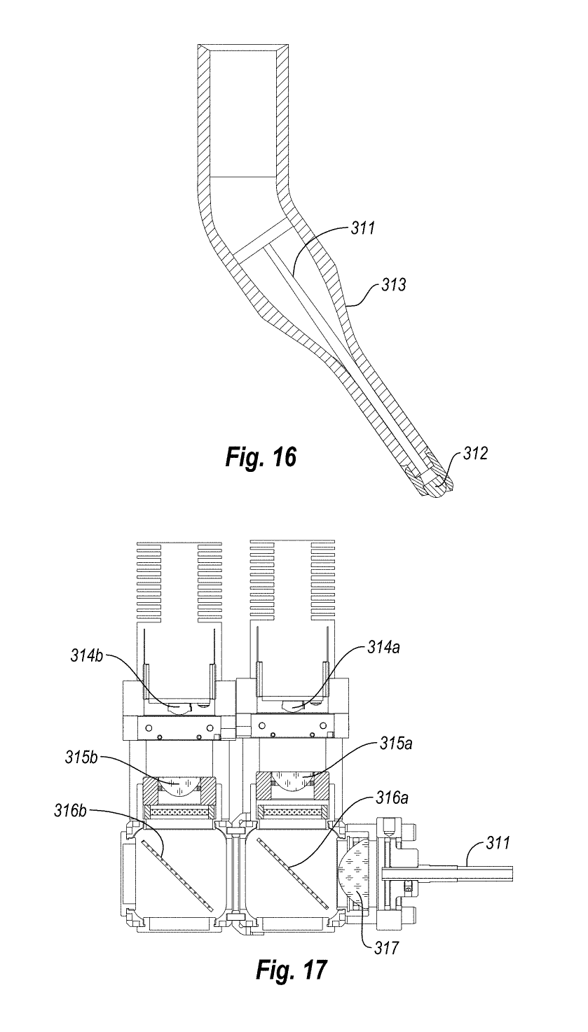

As described above, the light source(s) can illuminate the targets in a manner that generates the target light therefrom. The wavelength of the light from the light source(s) can be different from wavelength of the target light generated by one, some, or all of the targets (e.g., the target light can be wavelength-shifted relative to the wavelength of the light sources that illuminate the target). FIGS. 16 and 17 illustrate portions of the pump light assembly according to an embodiment. Specifically, FIG. 16 is a cross-sectional view of a light guide according to an embodiment, and FIG. 17 is a cross-sectional view of an illuminator according to an embodiment.

As shown in FIG. 16, the light guide can include an optical fiber 311 and a focusing lens 312. The optical fiber 311 can channel light of one or more suitable wavelengths to the focusing lens 312 that can project the light onto the selected location of the assay cartridge (as described above). Moreover, in an embodiment, the optical fiber 311 or the focusing lens 312 can be protected by or sealed at least partially in a shield 313. In any event, according to an embodiment, the pump light from the light guide can be positioned near the selected location on the assay cartridge, such as to produce luminescence of the targets at the selected location.

As shown in FIG. 17, the illuminator can operably couple to the optical fiber 311. Hence, the optical fiber 311 can deliver the light of suitable wavelength(s) to the focusing lens (as described above in connection with FIG. 16). In an embodiment, the illuminator can include lights 314a, 314b (e.g., LEDs) of suitable wavelength(s) that can provide the suitable pump light to the optical fiber 311. For example, the light emitted by the lights 314a, 314b can be collimated by respective lenses 315a, 315b on corresponding redirecting optical elements 316a, 316b. Moreover, the light redirected by the redirecting optical elements 316a, 316b can be projected onto a lens 317 that can focus the light on the optical fiber 311 (e.g., for further transmission to the focusing lens and to the selected location on the assay cartridge).

Generally, the multi-test assay system can analyze biological material in any number of assay cartridges (e.g., in parallel). For example, the multi-test assay system can include any suitable number of receptacles (e.g., any number of trays) that can accept assay cartridges, corresponding actuators (for controlling cartridge controls on the assay cartridges), and spectrographs for analyzing the target light from one or more selected locations on the assay cartridges. In an embodiment, a single controller can control multiple trays, actuators, spectrographs, or combinations thereof. Alternatively, multiple controllers can control multiple receptacles, actuators, spectrographs, or combinations thereof.

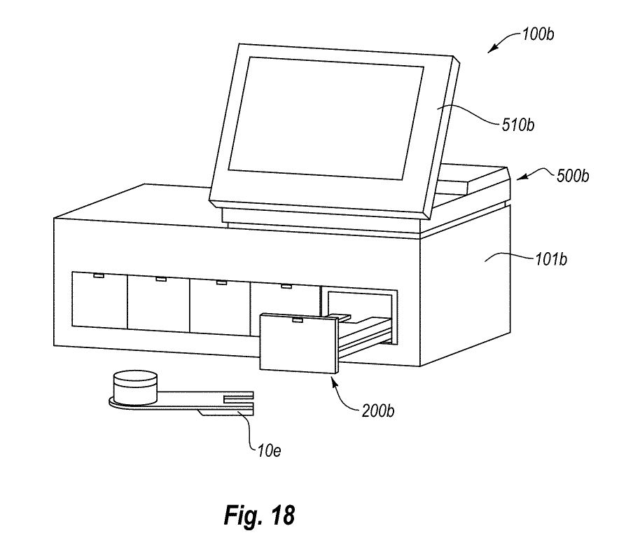

FIG. 18 is an axonometric view of a schematic illustration of a multi-test assay system 100b, according to an embodiment. Except as otherwise described herein, the multi-test assay system 100b and its elements and components can be similar to or the same as any of the multi-test assay systems described above and their respective element and components. For example, the multi-test assay system 100b can include multiple tray assemblies 200b, light analyzer assemblies, actuator assemblies, test monitoring systems, etc., as described above in connection with multi-test analyzer assemblies 100, 100a (FIGS. 1A-4B and FIGS. 6A-14C). Hence, for example, the tray assemblies 200b can receive any number of suitable assay cartridges, such as assay cartridge 10e. For example, each of the multiple tray assemblies 200b can be associated with a corresponding one or more of the light analyzer assemblies.

In an embodiment, the tray assemblies 200b, light analyzer assemblies, actuator assemblies, and test monitoring systems of the multi-test assay system 100b can be enclosed in an enclosure 101b. In an embodiment, the multi-test assay system 100b can include a cooling system (e.g., one or more fans and one or more openings) to cool electrical elements or components enclosed by the enclosure 101b.

In an embodiment, the multi-test assay system 100b can include a controller 500b that can be similar to any of the controllers described above. In an embodiment, the multi-test assay system 100b can include an output device, such as a display 510b. The display 510b can be operably coupled to the controller 500b and can display information (e.g., test results, alarms, etc.) responsive to one or more signals received from the controller 500b. Moreover, the multi-test assay system 100b can include one or more input devices operably coupled to the controller. For example, the display 510b can include a touch screen. Additionally or alternatively, the controller 500b can be coupled to any number of suitable input devices, such as keyboard, microphone, etc. Likewise, the controller 500b can be operably coupled to any number of output devices, such as printers, speakers, etc.

In an embodiment, the multi-assay system 100b can have a modular design or configuration. For example, the tray assemblies 200b, light analyzer assemblies, actuator assemblies, test monitoring systems of the multi-test assay system 100b, or combinations thereof may be selectively removable or attachable one to another in a manner that can configure the multi-test assay system 100b. For example, another (not illustrated) tray assembly, light analyzer assembly, actuator assembly, test monitoring system, or combinations thereof can be operably connected or coupled to the controller 500b to reconfigure the multi-test assay system 100b to have an additional tray assembly configured to operate on additional assay cartridges in parallel with the existing tray assemblies 200b. Additionally or alternatively, at least one of existing tray assemblies 200b, light analyzer assemblies, actuator assemblies, test monitoring systems, or combinations thereof can be detached from the multi-test assay system 100b or coupled to another multi-test assay system.

It will be understood that a wide range of hardware, software, firmware, or virtually any combination thereof can be used in the controllers described herein. In one embodiment, several portions of the subject matter described herein can be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more programs running on one or more processors (e.g., as one or more programs running on one or more microprocessors), as firmware, or as virtually any combination thereof. In addition, the reader will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution.

In a general sense, the various embodiments described herein can be implemented, individually and/or collectively, by various types of electro-mechanical systems having a wide range of electrical components such as hardware, software, firmware, or virtually any combination thereof; and a wide range of components that can impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs.

In a general sense, the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). The subject matter described herein can be implemented in an analog or digital fashion or some combination thereof.

The herein described components (e.g., steps), devices, and objects and the discussion accompanying them are used as examples for the sake of conceptual clarity. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, the reader can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

In some instances, one or more components can be referred to herein as “configured to.” The reader will recognize that “configured to” or “adapted to” are synonymous and can generally encompass active-state components and/or inactive-state components and/or standby-state components, unless context requires otherwise.

While particular aspects of the present subject matter described herein have been shown and described, it will be apparent that, based upon the teachings herein, changes and modifications can be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense the convention (e.g., “a system having at least one of A, B, or C” would include but not be limited to systems that have A alone, B alone, C alone, A and B together, A and C together, B and C together, and/or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, any recited operations therein can generally be performed in any order. Examples of such alternate orderings can include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, the various aspects and embodiments disclosed herein are for purposes of illustration and are not intended to be limiting, with the true scope and spirit being indicated by the following claims.

What is claimed is:

1. A multi-test assay system for assaying a biological sample in an assay cartridge, the multi-test assay system comprising:
one or more cartridge-locator elements sized and configured to position and orient the assay cartridge;
one or more actuators positioned and configured to interface with and operate one or more corresponding assay controls on the assay cartridge;
one or more light sources configured to illuminate one or more selected locations relative to the one or more cartridge-locator elements; and
a light analyzer assembly including:
an image detector; and
a spectrograph configured to transform target light received from at least one of the one or more selected locations to dispersed-target light received at the image detector.

2. The multi-test assay system of claim 1, further comprising a controller operably coupled to the image detector, the controller being configured to determine one or more wavelengths of a signal light within the target light, the signal light being generated from the biological sample producing one or more selected wavelengths of light.

3. The multi-test assay system of claim 2, wherein the signal light is generated from a reaction in the biological sample.

4. The multi-test assay system of claim 2, wherein the controller is configured to correlate the determined one or more wavelengths of the signal light to at least one diagnosis.

5. The multi-test assay system of claim 1, further comprising:
a base; and
a tray connected to the base and movable relative thereto, the tray includes the one or more cartridge-locator elements and is sized and configured to accept the assay cartridge.

6. The multi-test assay system of claim 5, further comprising one or more clamps movable relative to the tray between clamped and unclamped positions, in the clamped position, the one or more clamps press the assay cartridge against the tray.

7. The multi-test assay system of claim 5, wherein the tray includes a salver sized and configured to accept the assay cartridge, the salver being movable relative to the tray.

8. The multi-test assay system of claim 7, further comprising a weighing assembly that includes:
a load cell connected to or integrated with the tray; and
a load block positioned and configured to press against the load cell in a manner that loads the cell with a combined weight of the salver and the assay cartridge therein.

9. The multi-test assay system of claim 7, further comprising a weighing assembly that includes:
a load cell positioned outside of the tray; and
a loader connection positioned and configured to transfer the weight of the salver and the assay cartridge therein onto the load cell.

10. The multi-test assay system of claim 1, further comprising a heating element positioned and oriented relative to the one or more cartridge-locator elements such as to contact the assay cartridge.

11. The multi-test assay system of claim 1, further comprising a cooling element positioned and oriented relative to the one or more cartridge-locator elements such as to contact the assay cartridge.

12. The multi-test assay system of claim 1, wherein the one or more actuators are movable relative to the one or more cartridge-locator elements from a disengaged location to an engaged location; and wherein in the engaged location, the one or more actuators are positioned to engage the one or more corresponding assay controls on the assay cartridge.

13. The multi-test assay system of claim 12, further comprising:
a base; and
a top plate, at least some of the one or more actuators are secured to the top plate and movable therewith from the disengaged location to the engaged location;
wherein, in the engaged location, the one or more actuators are positioned closer to the base.

14. The multi-test assay system of claim 13, further comprising:
a guide assembly slidably connecting the top plate to the base; and
a clamping actuator operably coupled to the top plate and configured to move the top plate between the disengaged location and the engaged location.

15. The multi-test assay system of claim 1, wherein the one or more actuators include one or more linear actuators, and each of the one or more linear actuators is configured to move an engageable portion thereof along a generally linear path.

16. The multi-test assay system of claim 15, wherein the one or more linear actuators include a first linear actuator at a first orientation and a second actuator at a second orientation that is substantially perpendicular to the first orientation.

17. The multi-test assay system of claim 1, wherein the one or more actuators include one or more rotary actuators, each of the one or more rotary actuators is configured to rotate an engageable portion thereof about corresponding rotation axis.

18. The multi-test assay system of claim 17, wherein at least one of the one or more rotary actuators is indexable between a first angular position and a second angular position.

19. The multi-test assay system of claim 17, wherein at least one of the one or more rotary actuators includes a magnetic rotary actuator positioned and configured to rotate one or more magnetic elements in the assay cartridge.

20. The multi-test assay system of claim 1, wherein the one or more actuators include a sonicator positioned and configured to vibrate at least a portion of the assay cartridge at one or more selected frequencies.

21. The multi-test assay system of claim 1, further comprising a camera having a field-of-view that captures at least a portion of the assay cartridge.

22. The multi-test assay system of claim 21, further comprising a controller operably coupled to the camera and configured receive one or more signals therefrom, the controller is configured to track flow of one or more fluids in the assay cartridge at least in part based on the one or more signals received from the camera.

23. The multi-test assay system of claim 22, wherein the controller is further configured to:
determine a change in reflection of the flowing fluids in the assay cartridge based at least partially on the one or more signals; and
determine a failed test based at least partially on the determined change in reflection of the flowing fluids.

24. The multi-test assay system of claim 1, wherein the one or more cartridge-locator elements include at least one of one or more walls, one or more posts, or one or more openings corresponding to one or more locator features on the assay cartridge.

25. A multi-test assay system for assaying biological samples in assay cartridges, the multi-test assay system comprising:
a base;
a plurality of receptacles operably coupled to the base, each of the plurality of receptacles including one or more cartridge-locator elements sized and configured to position and orient the assay cartridges;
one or more actuators positioned and configured to interface with and operate one or more corresponding assay controls on the assay cartridge;
one or more light sources configured to illuminate one or more selected locations relative to each of the plurality of trays; and
a plurality of light analyzer assemblies, each light analyzer assembly of the plurality of light analyzer assemblies including:
an image detector; and
a spectrograph transforming target light from at least one of the one or more selected locations to dispersed-target light received at the image detector.

26. The multi-test assay system of claim 25, further comprising a controller operably coupled to each of the image detectors, the controller being configured to determine one or more wavelengths of a signal light within the target light, the signal light being generated from a reaction in respective ones of the biological samples producing one or more selected wavelengths of light.

27. The multi-test assay system of claim 26, wherein the controller is configured to correlate the determined one or more wavelengths of the signal light to at least one diagnosis.

28. The multi-test assay system of claim 25, wherein the plurality of receptacles includes one or more trays.

29. The multi-test assay system of claim 28, further comprising one or more salvers configured to accept the assay cartridge, each salver of the one or more salvers being associated with and movable relative to corresponding one of the one or more trays.

30. The multi-test assay system of claim 25, further comprising a plurality of weighing assemblies, each of the plurality of weighing assemblies including:
a load cell connected to or integrated with a corresponding tray of the one or more trays; and
a load block positioned and configured to press against the load cell in a manner that loads the cell with a combined weight of the corresponding salver and a corresponding assay cartridge therein.

31. The multi-test assay system of claim 25, further comprising a plurality of weighing assemblies, each of the plurality of weighing assemblies including:
a load cell positioned outside of corresponding tray of the plurality of trays; and
a load connection positioned and configured to transfer the weight of the corresponding salver and a corresponding assay cartridge therein onto the load cell.

32. The multi-test assay system of claim 25, further comprising one or more of one or more heating elements or one or more cooling elements positioned and oriented relative to each tray of the plurality of trays.

33. The multi-test assay system of claim 25, wherein the one or more actuators are movable relative to each tray of the plurality of trays from a disengaged location to an engaged location, in the engaged location, the one or more actuators being positioned to engage the one or more corresponding assay controls on the assay cartridge.

34. The multi-test assay system of claim 33, further comprising:
a top plate, at least some of the one or more actuators are secured to the top plate and movable therewith from the disengaged location to the engaged location;
wherein, in the engaged location, the one or more actuators are positioned closer to the base.

35. The multi-test assay system of claim 25, further comprising a camera having a field-of-view that captures at least a portion of at least one assay cartridge in a corresponding tray of the plurality of trays.

36. The multi-test assay system of claim 35, further comprising a controller operably coupled to the camera and configured to receive one or more signals therefrom, the controller is configured to track flow of one or more fluids in the at least one assay cartridge at least partially based on the one or more signals received from the camera.

37. The multi-test assay system of claim 36, wherein the controller is further configured to:
determine a change in reflection of the flowing fluids in the at least one assay cartridge based at least in part on the one or more signals; and
determine a failed test based at least partially on the determined change in reflection of the flowing fluids.

38. A multi-test assay system, comprising:
one or more assay cartridges each of which includes one or more reservoirs sized and configured to contain one or more biological samples, each of the one or more assay cartridges including:
one or more assay controls positioned and configured to manipulate the one or more biological samples contained in the one or more containment features or one or more reagents for reacting with the one or more biological samples; and
one or more locator features;
a tray sized and configured to accept each of the one or more assay cartridges, the tray including one or more cartridge-locator elements configured and located to engage corresponding ones of the one or more locator features to position and orient each assay cartridge;
one or more actuators positioned and configured to engage and operate the one or more corresponding assay controls;
one or more light sources configured to illuminate one or more selected locations on each assay cartridge positioned on the tray; and
a light analyzer assembly including:
an image detector; and
a spectrograph configured to disperse target light from at least one of the one or more selected locations to dispersed-target light received at the image detector.

39. The multi-test assay system of claim 38, wherein the one or more assay cartridges include a first assay cartridge configured for performing a first assay and a second assay cartridge configured for performing a second assay that is different from the first assay.

40. The multi-test assay system of claim 38, further comprising a controller operably coupled to the image detector, the controller being configured to determine one or more wavelengths of a signal light within the target light, the signal light being generated from a reaction producing one or more selected wavelengths of light, the controller is configured to correlate the determined one or more wavelengths of the signal light to at least one diagnosis.

41. The multi-test system of claim 40, wherein each of the one or more assay cartridges includes an identifier, and the controller is configured to generate one or more signals for operation of the one or more actuators at least in part based on the identifier.
